(19) United States
(12) Patent Application Publication
(10) Pub. No.: US 2013/0290216 A1
(43) Pub. Date: Oct. 31, 2013

(54) SYSTEMS FOR, AND METHODS OF MAKING AND EXECUTING, INVESTMENT TRANSACTION DECISIONS

(71) Applicant: Mark C. Scheffler, Appleton, WI (US)

(72) Inventor: Mark C. Scheffler, Appleton, WI (US)

(21) Appl. No.: 13/586,395

(22) Filed: Aug. 15, 2012

Related U.S. Application Data
(60) Provisional application No. 61/640,413, filed on Apr. 30, 2012.

(51) Int. Cl. G06Q 40/06

(52) U.S. Cl. 705/36 R

(57) ABSTRACT

Methods and systems for a trading strategy, for making and executing investment transaction decisions. The methods and systems operate on two levels, based on sets of at least three simple moving averages, including back testing to establish a decision base for decision making. As a first level, the trading strategy ascertains a general direction of the market for a specific investment vehicle. Once the general direction of the market for that investment vehicle has been determined, the trading strategy uses multiple simple moving average crosses as basis for triggering transaction signals and/or transaction signal alerts.

### CROSS-REFERENCE TO RELATED APPLICATIONS

This application claims priority under 35 U.S.C. §120, as a Non-Provisional patent application, to application Ser. No. 61/640,413, filed Apr. 30, 2012, which is incorporated herein by reference in its entirety.

### BACKGROUND OF THE INVENTION

The present invention relates to systems and methods for making investment transaction decisions, and executing such transactions, using computer-generated transaction signals.

Some within the financial community believe that one can predict future price movement of an investment vehicle by analyzing current and past financial information related to that investment vehicle. A variety of types of financial information provide potential inputs to the prediction process, including historical and current values of any quantifiable property of the investment vehicle or related investment vehicles, such as price and volume.

So called “studies” represent the output of certain mathematical calculations which have been applied to such financial information. For example, a study can be a simple moving average based on a selected, e.g. closing, price of the respective investment vehicle.

Some people believe that, based on such data analysis, one can arrive at a set of rules which, when followed, will lead to a favorable investment result. Such set of rules may be called a financial trading system. An example of a trading system for an investment vehicle may include a first rule, or set of rules, for determining when to enter a position in the respective investment vehicle, and a second rule, or set of rules, for determining when to exit such position in the respective investment vehicle.

A specific example of a simple trading system can include such rules as:

When the 50 day simple moving average, of the closing price of the respective investment vehicle, crosses above the 200 day simple moving average, of the closing price of the respective investment vehicle, then buy a specified number of contracts or shares of the respective investment vehicle. When the 50 day simple moving average, of the closing price of the respective investment vehicle, crosses below the 200 day simple moving average, of the closing price of the respective investment vehicle, then sell the specified number of contracts or shares of the respective investment vehicle.

A trading system may include a single rule, and the above simple example is merely intended to illustrate the term trading system. In the alternative, a trading system may include multiple rules, each of which may be simple, or relatively more complex, and each of which may be applied when a particular set of circumstances is encountered in the respective market.

Certain trading system rules can be implemented either manually, or on a computer or other data processing system. Such computer may evaluate relevant information from a wide variety of categories of information, and typically evaluates a predetermined set of investment vehicle properties and/or studies.

More complex trading system rules, on the other hand, may require complex, or re-iterative calculations, and such timeliness in generation of transaction signals and/or in implementation of respective transactions so determined, that computer calculation is the only useful means by which to generate the results called for by the respective trading system.

Thus, where a trading system requires complex calculations, or many repetitions of a calculation, or related calculations, use of a computer system to perform such calculations may be the only way such trading system can be useful in a time frame that allows meaningful implementation of the signals generated by the trading system before market activity so changes market prices that such transaction signals are no longer useful.

Such evaluation may be performed in real time based on real time input of information regarding the investment vehicle, or may be performed at predetermined times, e.g. periodically at predetermined intervals, or in response to predetermined trigger events, such as user inputs or inputs from other software applications or newly-developed, or newly-developing, data. Where a computer is used in generating such transaction signals, the computer may take a predetermined action when conditions specified in a related trading system generate a such transaction signal.

Certain applications to develop and execute computer-assisted trading systems already exist. Such applications typically allow a user to define a trading system, as well as a universe of investment vehicles to be monitored. The trading system then monitors relevant financial information pertaining to the universe of specified investment vehicles, in real time, and takes specified action when certain conditions, specified in the trading system, are met. Possible actions include anything from simply generating a signal, or alerting a system user to the fact that the predetermined conditions have been met, to placing a transaction order based on such signal.

Some trading systems provide for the ability to back test the trading system against historical transactional data. Back testing applies the trading system to historical data and the system identifies times when a transaction signal would have been generated had the trading system been running at the respective historical time. Assuming the back testing actions include hypothetical buy and sell transactions relating to a particular investment vehicle, a user can use the trading system to generate statistics showing how the trading system would have performed, had the user started using the trading system during the historical period used as input for the back test.

Examples of trading systems applications which are believed to have become available include:

TradeStation system available at http://www.tradestation.com;

ESignal system available at http://www//esignal.com;

Metastock system available at http://equis.com;

FiberTec system available at http://www.fibertec.com;

StrategyRunner system available at http://www.strategyrunner.com; and

TradeNavigator system available at http://www.genesisft.com.

The above systems are believed to provide functionalities relating to
(i) allowing a user to define the trading system;
(ii) allowing a user to specify a historical period and have the application back test the system using data generated during a specified historical period, resulting in hypothetical historical performance metrics; and
(iii) allowing a user to use the trading system for “live execution”, namely the user can specify that the respective trading system perform certain actions in real time according to the rules which govern the action of the trading system, including ordering the execution of certain transactions.

Such applications provide well-known benefits including the fact that the trading system can constantly monitor the market and can, if so instructed, take action immediately upon occurrence of certain events. By contrast, a single human being does not have the mental capacity to simultaneously monitor all desired, e.g. a large number, of potential investment vehicle targets with a timeliness corresponding to the speed and accuracy of the calculations which can be performed by computers. Neither does a single human being have the capacity to routinely monitor the market, or even any particular investment vehicle, or set of investment vehicles, continuously for a prolonged period of time of more than several hours without an intervening period of rest.

In addition, a machine-implemented trading system controlled by a predetermined set of instructions always follows the specified rules, and thus is not influenced, short term, by market psychology or by human emotion, or by physical or emotional stress, such as fatigue.

Still further, using back testing, a user can see how the trading system has performed historically, and can choose to project, from such historical results, how the trading system will perform in the future, all before committing actual money to any particular investment vehicle.

The most commonly used trading systems depend, for increase in value of a portfolio, on a rising market for the investment vehicles of interest. Namely, the prices of the respective individual investment vehicles must rise in order for the value of the portfolio to rise.

Certain short term trading systems attempt to capture small incremental increases in the price of an investment vehicle using many short-term trades. But short term trading involves many transactions, and each such transaction attracts a respective transaction fee/cost. While each such fee/cost may be insubstantial, the overall cost of many such transactions can have a substantial detrimental effect on the overall value of the portfolio.

History shows that there are a substantial number of intermediate-term changes in the time-based direction of market price of many investment vehicles. However, to Applicant's knowledge, there is limited, if any, availability of decision-making systems, trading strategies, which are overall neutral to the general intermediate-term direction of the price of the investment vehicle of interest. And yet, if one were able to positively capture major portions of the both upwardly-moving and downwardly-moving intermediate changes in direction of the price of a respective investment vehicle, one could improve the portfolio performance as opposed to a buy and hold trading strategy, or strategies which capture advantage only when price of the investment vehicle is rising, while limiting transaction costs.

Accordingly, it is desirable to provide a trading strategy defining corresponding methods and systems which are neutral to the general direction of the market, capturing value in both rising markets and declining markets, while incurring only limited transaction costs.

It is further desirable to provide a trading strategy which determines, as a preliminary screen, whether the price of an investment vehicle of interest is generally rising or generally declining, and adopting a first effective trading strategy in a rising market, and adopting a second different effective trading strategy in a declining market.

It is still further desirable to provide the user with the option of either (i) allowing the computer to automatically place transaction orders, namely to effectively make trades, when a transaction signal is generated, or (ii) to withhold such automatic transaction authority, leaving the user the opportunity to make further analysis of, or inquiry into, the situation, whereby the user makes the final decision to place a transaction order according to the transaction signal, or not.

Thus, it is desirable to provide a trading strategy which first determines the general direction of the market for a particular investment vehicle, and then applies a trading strategy which follows the general-direction lead of the market, namely a trading strategy which provides a positive return on investment whatever the then-current intermediate-term direction of the market for that particular investment vehicle.

### SUMMARY OF THE INVENTION

This invention provides systems and methods for generating, and executing, investment transaction decisions. The methods involve a trading strategy which generally operates on two levels, based on multiple simple moving averages, including back testing to establish a historical database of theoretical transactions which serves as a reference base for generating transaction/trading decisions. At a first level, the trading strategy can ascertain the general direction of the market, either up or down, for a particular investment vehicle at a particular point in time. The trading strategy uses multiple simple moving averages as basis for generating transaction signals and transaction signal alerts. A transaction signal indicates that a transaction should be executed at a specified time. A transaction alert is a communication which predicts that a transaction signal is expected to be generated at a specified time in the future, within the succeeding few days. The trading strategy accommodates user inputs at various levels of the analysis, and multiple computer-type screen displays relate to the analysis and alerts, and the corresponding trading strategy.

In a first family of embodiments the invention comprehends a method of making investment transaction decisions, comprising selecting an investment vehicle; downloading, from a resource database, historical price data for the selected investment vehicle, for a selected time period; employing a first set of “n” simple moving averages, represented by “SMA1, SMA2, SMA3 . . . ”, where “n” is at least 3, back testing, by calculations, simple moving average crosses using the first set of simple moving averages and a set of criteria to trigger transaction signals regarding theoretical historical transactions, thereby generating a first set of theoretical historical transaction data and dates, and corresponding first theoretical managed trading results over a defined past period of time, and storing the first trading results in electronic memory; selecting a second different set of “n” simple moving averages designated by the digits “SMA1, SMA2, SMA3 . . . ”, where “n” is at least 3; repeating the back testing using the second set of simple moving averages and the same set of criteria and thereby generating a second set of theoretical historical transaction data and dates, and corresponding second theoretical managed trading results, over the same defined past period of time; comparing the second back-tested theoretical managed trading results to the first back-tested theoretical managed trading results and, based on the compared results, determining which of the first and second sets of SMA's produces a greater return on investment and is thus a then-current preferred set of simple moving averages; retaining in memory, as the then-current preferred set of simple moving averages, that one of the first and second sets of simple moving averages which produced the greater return on investment; periodically back testing additional sets of “n” simple moving averages, and thereby developing an ongoing stream of theoretical managed trading results; after each such back test, comparing the newly-developed trading results with the trading results from the existing preferred set of simple moving averages and thereby determining a new then-current preferred set of simple moving averages; retaining the then-current preferred set of simple moving averages in memory as the existing preferred set of simple moving averages; and after obtaining the second back test results, making transaction decisions based on the back testing, including transaction signals recently generated using the then-current preferred set of simple moving averages.

In some embodiments, the method further comprises using a random selection process to randomly select each of the simple moving averages in the second set of simple moving averages.

In some embodiments, the method further comprises using a random selection process to randomly select each of the simple moving averages in each of the sets of simple moving averages, optionally less one set of simple moving averages.

In some embodiments, the method further comprises generating a computer-type screen display which represents the fraction of the transaction signal combinations which produced profitable trades.

In some embodiments, the method further comprises generating a computer-type screen display which represents cumulative return based on transactions executed according to the transaction signals, as well as cumulative return based on a buy and hold strategy.

In some embodiments, the method further comprises providing a computer-type screen display having an interactive computer interface which allows a user to select, for use in computing trading results, any of (i) a manually specified set of simple moving averages, (ii) a locked-in previously-selected, preferred set of simple moving averages, or (iii) a periodically updated set of simple moving averages.

In some embodiments, the method further comprises providing a computer-type screen display, having an interactive computer interface which allows a user to enable or disable half positions, and/or to enable or disable short selling the investment vehicle, as screening criteria in calculating the back-test results.

In some embodiments, the method further comprises using a computer to calculate, as part of the back testing, the return on investment using the then-current preferred set of simple moving averages, and corresponding trading results using a buy and hold strategy over individual periods of time, within the selected time period and shorter than the selected time period.

In some embodiments, the method further comprises providing an interactive computer interface which enables a user to specify a shorter period of time, within the selected time period, or to specify the entire selected period of time, and to command a computer to calculate overall cumulative return for the specified period of time, as well as optionally calculating the fraction of the transaction signal combinations which theoretically produced profitable trades, and the fraction of the transaction signal combinations which theoretically produced unprofitable trades, using the then-current preferred set of simple moving averages.

In some embodiments, the method further comprises providing a computer-type screen display of a graph of hypothetical growth of an investment over the selected period of time or the shorter period of time, whichever is specified by the user, representing a managed trading strategy and a buy and hold strategy.

In some embodiments, the method further comprises providing a computer-type screen display which shows each transaction as signaled by the back-testing process, including (i) transaction date, (ii) transaction action taken, and (iii) accumulated value of an investment as of the transaction date, using the then-current preferred set of simple moving averages.

In some embodiments, the method further comprises providing a computer-type screen display which shows average trade efficiency for an investment vehicle using the then-current preferred set of simple moving averages, over the selected time period.

In some embodiments, the method further comprises calculating, and storing in non-temporary memory, maximum drawdown for the selected investment vehicle, and providing a computer-type screen display which shows such maximum drawdown.

In some embodiments, “n” is at least 5.

In some embodiments, the method further comprises periodically updating the historical price data, from such resource database, to reflect current market information, and using the updated data in subsequently-performed back testing, and corresponding selection of the then-current preferred set of simple moving averages, each time using a newly-selected set of simple moving averages, and by using results of such subsequently-performed back testing, generating additional transaction signals as consistent with the defined set of criteria.

In some embodiments, the calculations are performed by a computer and, upon generation of a real time such transaction signal, the computer sends a communication to a market platform where the respective investment vehicle can be purchased and/or sold, and places a transaction order based on such real time transaction signal.

In a second family of embodiments, the invention comprehends a method of making investment transaction decisions, comprising selecting a first investment vehicle; downloading, from a resource database, historical price information for the first selected investment vehicle, for a selected period of time employing multiple first sets of “n” simple moving averages, each such first set of “n” simple moving averages being represented by “SMA1, SMA2, SMA3 . . . ,” where “n” is at least 3, back testing the first investment vehicle using the multiple first sets of simple moving averages, and simple moving average crosses, according to a first set of criteria, using at least 200 days of price information with at least 500 sets of simple moving averages, at a rate of at least 250 sets of simple moving averages per minute, to determine a first set of hypothetical transaction signals and thereby obtaining first trading results for the selected period of time; selecting a second investment vehicle; downloading, from the resource database, historical price data for the second selected investment vehicle, for the selected period of time; employing multiple second sets of “n” simple moving averages, each such second set of “n” simple moving averages being represented by “SMA1, SMA2, SMA3 . . . ,” where “n” is at least 3; back testing the second investment vehicle using the second multiple sets of simple moving averages, and simple moving average crosses, according to the same first set of criteria, using at least 200 days of price information with at least 500 sets of simple moving averages, at a rate of at least 250 sets of simple moving averages per minute, to determine a second set of hypothetical transaction signals and thereby obtaining second trading results for the selected period of time; as part of the back testing of each such investment vehicle, determining which of the simple moving average sets tested provides greatest overall trade efficiency for the respective selected investment vehicle, and selecting that respective set of simple moving averages as a then-current preferred set of simple moving averages; and using the determined trade efficiency as at least one selection factor, selecting one or more of the investment vehicles so back tested as transaction candidates.

In a third family of embodiments, the invention comprehends a method of making investment transaction decisions, comprising selecting a first investment vehicle; downloading, from a resource database, historical price information for the first selected investment vehicle, for a selected period of time; employing multiple first sets of “n” simple moving averages, each such first set of “n” simple moving averages being represented by “SMA1, SMA2, SMA3 . . . ,” where “n” is at least 3, back testing the first investment vehicle using the multiple first sets of simple moving averages, and simple moving average crosses, according to a first set of criteria, using at least 200 days of price information with at least 500 sets of simple moving averages, at a rate of at least 250 sets of simple moving averages per minute, to determine a first set of hypothetical transaction signals and thereby obtaining first trading results for the selected period of time; selecting a second investment vehicle; downloading, from the resource database, historical price information for the second selected investment vehicle, for the selected period of time; employing multiple second sets of “n” simple moving averages, each such second set of “n” simple moving averages being represented by “SMA1, SMA2, SMA3 . . . ,” where “n” is at least 3; back testing the second investment vehicle using the multiple second sets of simple moving averages, and simple moving average crosses, according to the same first set of criteria, and using the same at least 200 days of price information with at least 500 sets of simple moving averages, at a rate of at least 250 sets of simple moving averages per minute, to specify a second set of hypothetical transaction signals and thereby obtaining second trading results for the selected period of time; as part of the back testing of each such investment vehicle, determining which of the sets of simple moving averages provides greatest return on investment for that investment vehicle, and calculating the maximum draw-down of value for that investment vehicle, from peak to valley, and selecting as the then-current preferred set of simple moving averages, that one set of simple moving averages, among all the sets of simple moving averages tested until that time, which produces the greatest return on investment; and using maximum draw-down as at least one selection factor, selecting one or more of the investment vehicles so back tested as transaction candidates.

In a fourth family of embodiments, the invention comprehends a method of making investment transaction decisions, comprising selecting a first investment vehicle; downloading, from a resource database, historical price information for the first selected investment vehicle, for a selected period of time; employing multiple first sets of “n” simple moving averages, each such first set of “n” simple moving averages being represented by “SMA1, SMA2, SMA3 . . . ,” where “n” is at least 3, back testing the first investment vehicle using the multiple first sets of simple moving averages, and simple moving average crosses, according to a first set of criteria to determine a first set of hypothetical transaction signals and thereby obtaining first trading results for the selected period of time; selecting a second investment vehicle; downloading, from the resource database, historical price information for the second selected investment vehicle, for the selected period of time; employing multiple second sets of “n” simple moving averages, each such second set of “n” simple moving averages being represented by “SMA1, SMA2, SMA3 . . . ,” where “n” is at least 3, back testing the second investment vehicle using the multiple second sets of simple moving averages, and simple moving average crosses, according to the same first set of criteria to specify a second set of hypothetical transaction signals and thereby obtaining second trading results for the selected period of time; as part of the back testing of each such investment vehicle, calculating the cumulative return on investment, within the database set; and using the cumulative return on investment as at least one factor, selecting one or more of the investment vehicles so back tested as a transaction candidate.

In some embodiments, “n” is at least 5 and the method further comprises periodically updating the historical price information, from such resource database, to reflect current, or nearly current, market information, and using the updated information to subsequently perform back testing, and corresponding selection of the then-current preferred set of simple moving averages, each time using a newly-randomly-selected set of simple moving averages, and by using results of such subsequently-performed back testing, generating additional transaction signals, and wherein, upon generation of a real time such transaction signal, a computer communicating such transaction signal to a market platform where the respective investment vehicle can be purchased and/or sold, and placing a transaction order based on such real time transaction signal.

In some embodiments the method further comprises updating and compiling the historical price data to memory at predetermined spaced time intervals.

In an fifth family of embodiments, the invention comprehends a method of making investment transaction decisions, comprising selecting an investment vehicle; downloading, from a resource database, historical price information for the selected investment vehicle, for a selected period of time; employing a first group of randomly-selected sets of “n” simple moving averages represented by “SMA1, SMA2, SMA3 . . . , where “n” is at least 3, back testing the set of simple moving averages using simple moving average crosses according to a first formula which allows shorting and positions to obtain a first then-current preferred set of simple moving averages, and corresponding set of transaction signals, and corresponding first trading results, using at least 200 days of price information with at least 500 sets of simple moving averages, at a rate of at least 250 sets of simple moving averages per minute; back testing a second group of randomly-selected sets of simple moving averages using simple moving average crosses according to the same first formula except disallowing one or both of shorting or ½ positions, to obtain a second then-current preferred set of simple moving averages, and a corresponding set of transaction signals, and corresponding second trading results; comparing the second trading results to the first trading results and thereby determining which of the first or second trading results would have produced a greater return on investment and selecting that respective back testing condition as preferred for generating future transaction signals, periodically updating the historical price data, from the resource database, and using the updated price data in subsequent back testing calculations; and generating transaction signals, according to the results selected, using the most current up-dated historical price data.

In a sixth family of embodiments, the invention comprehends a data processing system, comprising a cloud computer, configured (i) to access a resource database containing historical market price information for multiple investment vehicles, to download the historical price information for any selected investment vehicle in the resource database, using predetermined criteria, in combination with downloaded such historical price information, to determine whether an intermediate direction for market price for a selected investment vehicle is a rising direction or a falling direction, and when the market price for the selected investment vehicle is rising, generating a transaction signal based on first simple moving average crosses according to a first set of signal generation criteria, and when the market price for the selected investment vehicle is falling, generating a transaction signal based on second simple moving average crosses according to a second set of signal generation criteria, different from the first signal generation criteria; and said system further comprising at least one user computer, coupled to the cloud computer, the at least one user computer being configured to enable a user to select a specific investment vehicle whose price information is available from the resource database, to communicate a selection of a respective investment vehicle to the cloud computer, and to receive respective transaction signals from the cloud computer for the selected investment vehicle, and wherein the coupling of the at least one user computer to the cloud computer is optionally an internet-based connection.

In some embodiments, multiple user computers are coupled to the cloud computer.

In a seventh family of embodiments, the invention comprehends a data processing system, comprising a computer system, the computer system being configured to access a resource database containing historical market price information for multiple investment vehicles; to enable a user to select a specific investment vehicle from the resource database; to download historical price information for any selected investment vehicle in the resource database; to, using the historical price information so downloaded for such selected investment vehicle, (i) using multiple sets of simple moving averages in sequence, each set containing at least “n” simple moving averages, represented by SMA1, SMA2, SMA3 . . . , where “n” is at least 3, back testing simple moving average crosses using a set of criteria to trigger transaction signals regarding theoretical historical transactions, thereby generating a separate set of theoretical historical transaction data and dates, and separate corresponding theoretical managed trading results, for each of the sets of simple moving averages so back tested, and (ii) selecting, as a then-current preferred set of simple moving averages, that back tested set of simple moving averages whose trading results, based on such transaction signals, provided greatest return on investment; periodically updating the information set, from the resource database, for the respective investment vehicle; after updating the data set, again back testing the investment vehicle using the updated data set, and generating any new transaction signals based on the updated data set and the same set of criteria.

### BRIEF DESCRIPTION OF THE DRAWINGS

FIG. 1 shows a general representation of a trading system useful in practicing the methods of the invention.

FIGS. 2A and 2B, collectively, show a flow chart illustrating methods of the invention.

FIG. 3 is a computer screen shot showing an early stage of entry into a computer program used in performing methods of the invention, showing three portfolio groups of investment vehicles.

FIG. 4 is a computer screen shot showing one of the portfolio groups expanded to show the individual investment vehicles.

FIG. 5 is a screen shot showing the individual investment vehicle lines expanded.

FIG. 6 is a screen shot showing an initial set of details regarding trade history results.

FIG. 7 is a screen shot as in FIG. 6, but where the calendar year presentation has been selected on the right side of the window.

FIG. 8 is a screen shot as in FIG. 7 where a shorter time period has been selected on the left side of the window.

FIG. 9 is a screen shot showing the Trade History in the right side of the window.

FIG. 10 is a screen shot showing calculated Trade Efficiency in the right side of the window.

FIG. 11 is a screen shot showing Maximum Drawdown in the right side of the window.

FIG. 12 is a screen shot showing the Portfolio window, and illustrating a transaction signal or a transaction alert signal in one of the investment vehicle lines.

FIG. 13 is a screen shot as in FIG. 12, with the respective investment vehicle line expanded to show an alert to an anticipated future transaction.

FIG. 14 illustrates a screen shot showing the transaction alerts of FIG. 13, shaded in the Trade History window.

FIG. 15 illustrates a screen shot showing the SMA Settings window for a first selected investment vehicle.

FIG. 16 shows a sideways-moving daily price chart with the Locked In Optimized SMA Settings of FIG. 15 superimposed on the graph.

FIG. 17 illustrates a screen shot showing the SMA Settings window for a second particular investment vehicle.

FIG. 18 shows a rising daily price chart with the Continuous Optimized SMA Settings of FIG. 17 superimposed on the graph.

The invention is not limited in its application to the details of construction, or to the arrangement of the components set forth in the following description or illustrated in the drawings. The invention is capable of other embodiments or of being practiced or carried out in various other ways. Also, it is to be understood that the terminology and phraseology employed herein is for purpose of description and illustration and should not be regarded as limiting. Like reference numerals are used to indicate like components.

### DETAILED DESCRIPTION OF THE ILLUSTRATED EMBODIMENTS

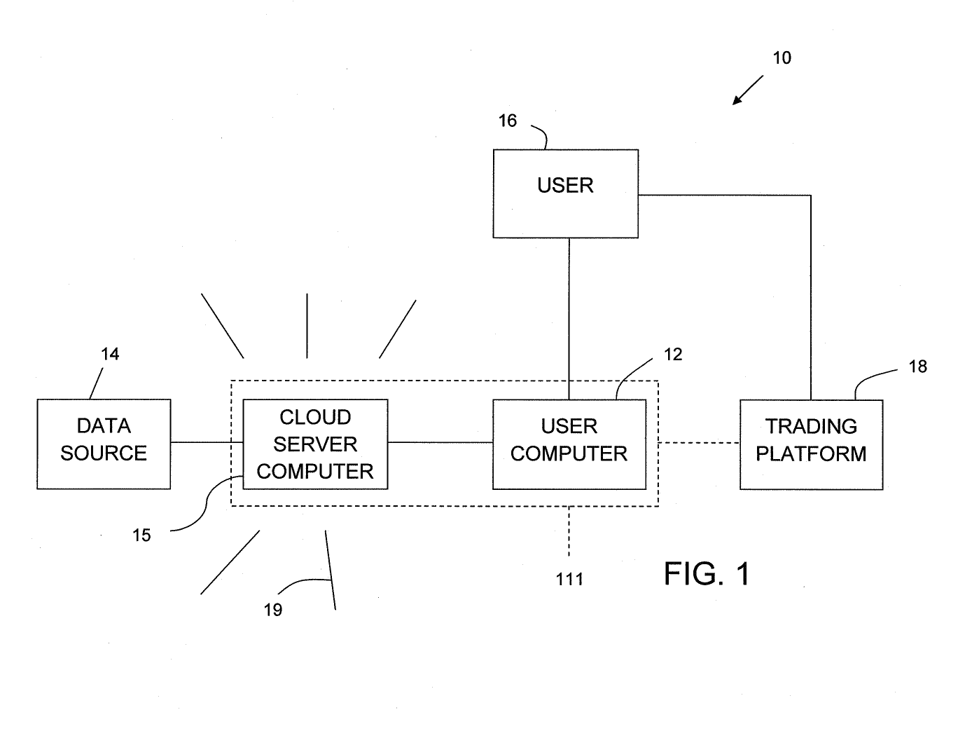

A system 10 useful in the methods of generating investment transaction signals and making investment transaction decisions of the invention is illustrated in FIG. 1. The system 10 includes a user computer 12 having access to software suitable for making the calculations anticipated by the invention. Such software, for example and without limitation, may be loaded directly on computer 12, may be available through an Internet connection, may be available through cloud server computer 15, or may be otherwise available such as through an external memory device. Computer 12 has access to a data source 14, typically through internet-based cloud server 16. User computer 12 is manipulated/instructed by a user 16 who has input capability to interact with the computer. Either computer 12 or user 16, or both, have access/connection to a trading platform 18, also known as a trading exchange, where investment vehicles of interest to the user can be purchased and/or sold, namely traded. Such exchange may be, for example, a stock exchange, a commodity exchange, a currency exchange, or the like.

FIG. 1 illustrates, by rays 19 emanating from cloud server 15, that the cloud server can serve, support, the demands of multiple user computers, and their respective users. Thus, multiple users and user computers can be sending information to, and receiving information from, cloud server 15 at any given point in time.

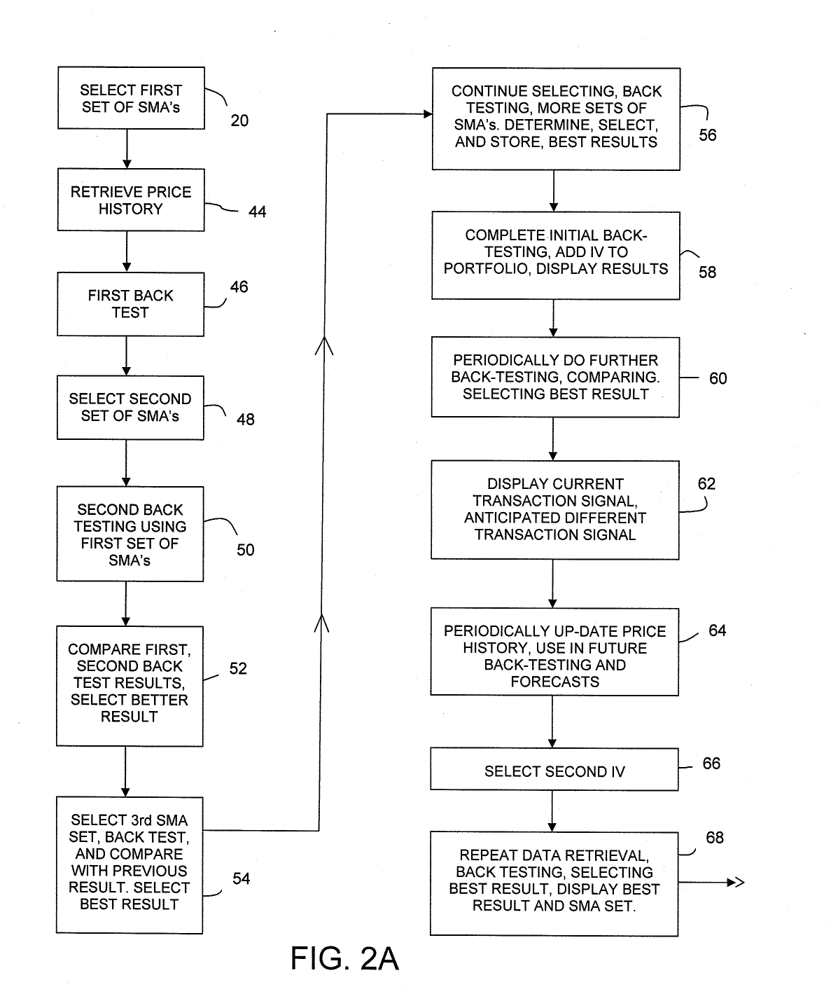

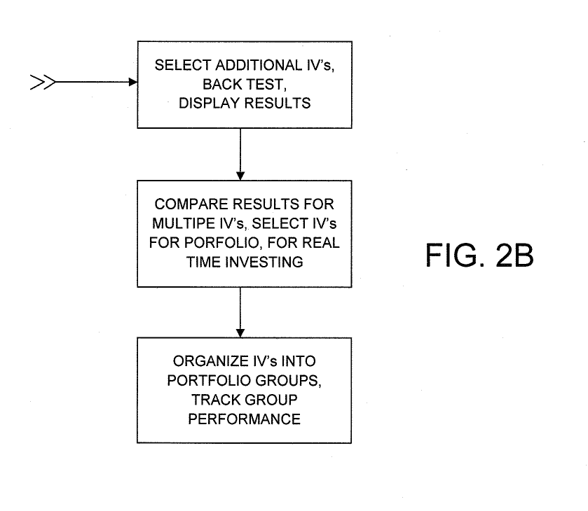

FIGS. 2A and 2B collectively show a flow chart of the methods of making investment transaction decisions of the invention. As illustrated in FIG. 2A, in the first step 20 in the methods of the invention, the user identifies an investment vehicle, such as Apple Computer stock (AAPL) to be investigated by the software.

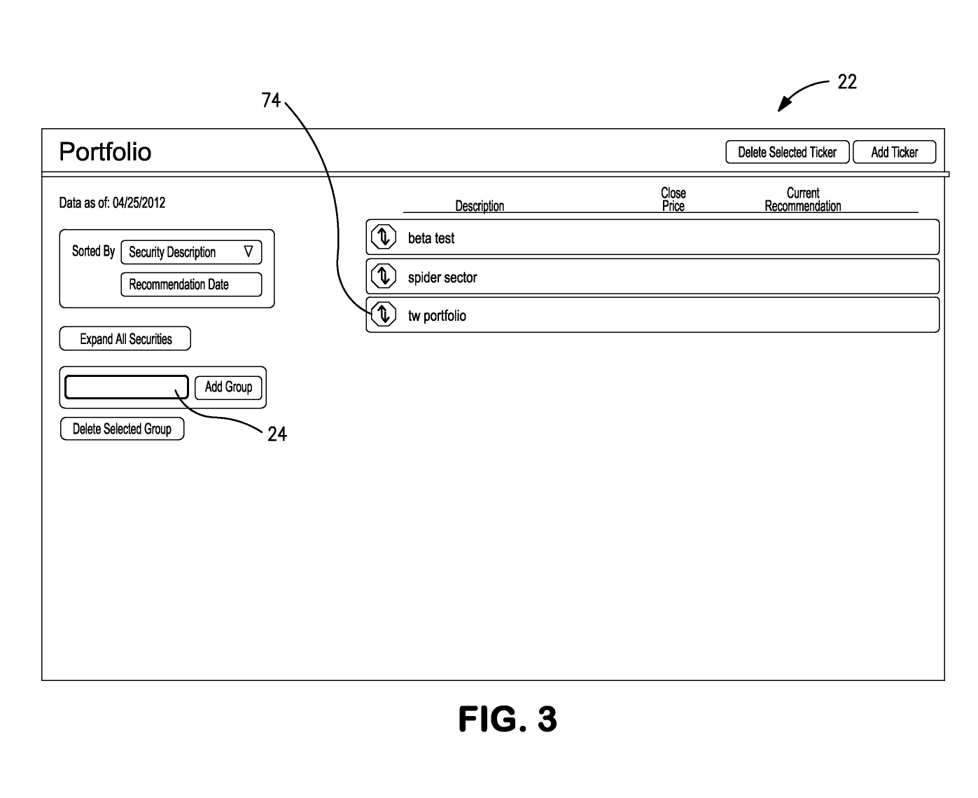

When the user opens the software interface on computer 12, the user may be presented with a portfolio page. A screen shot of a typical portfolio page 22 is illustrated in FIG. 3. As suggested by FIG. 3, the user can identify one or more groups of investment vehicles to be monitored by the software. A group of investment vehicles is identified by entering the desired name of the group in the space 24 provided on the portfolio page and selecting the “Add Group” button. The software then moves the group name to the right side of the page. In FIG. 3, three groups have been identified, namely the beta test group, the spider sector group, and the “tw portfolio” group.

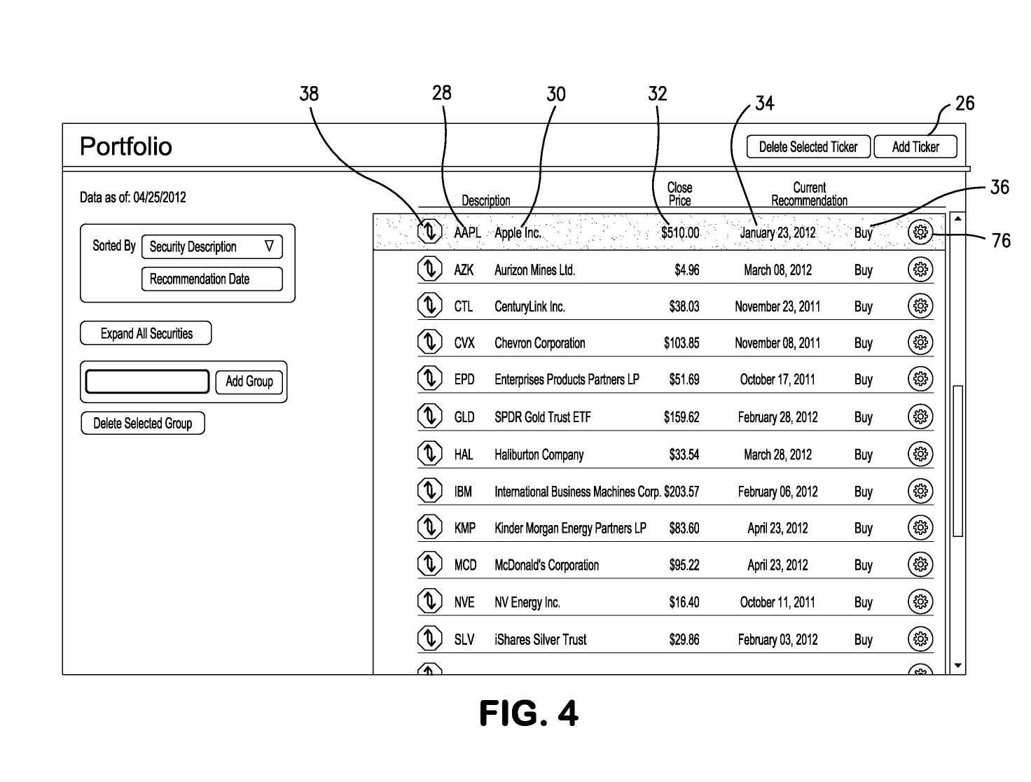

The user can add specific investment vehicles to be monitored by the software by selecting the “Add Ticker” button 26. When the Add Ticker button is selected, a window opens to enable the user to enter the symbols representing a desired investment vehicle. FIG. 4 illustrates a view of the portfolio page after several investment vehicles have been identified through use of the Add Ticker button. Each such investment vehicle is represented on a single line of the portfolio page. AAPL is representative. The representation for AAPL shows the ticker symbol 28, the name 30 of the company or other investment vehicle, the most recent dose price 32, the most recent date 34 on which the software generated a transaction signal for AAPL, in this case Jan. 23, 2012, and the nature 36 of the transaction signal, which was a “Buy” signal.

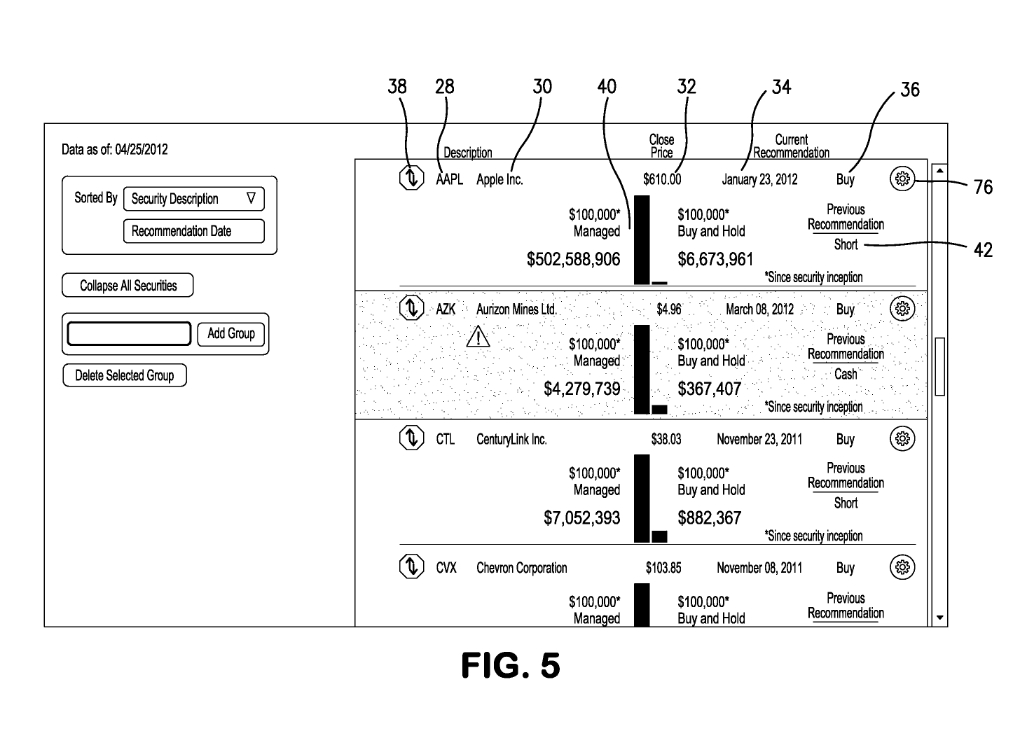

The up/down arrows 38 at the left of the ticker symbol line can be activated/selected to expand the amount of information which is available on the portfolio page. FIG. 5 illustrates the expanded view of the portfolio page. In the expanded view, the ticker symbol line adds two additional pieces of information. First, the current value 40 of an initial invested amount is shown, both numerically and using bar charts, both for a “managed” strategy according to methods of the invention, and for a “buy and hold” strategy. Second, the previous recommendation 42 is shown. In the example illustrated in FIG. 5, for AAPL, the previous recommendation was “Short”.

When the user adds a specific investment vehicle, such as AAPL, to be monitored, in the next step, designated as 44 in FIG. 2A, user computer 12 communicates with cloud server computer 15 to retrieve date-specific price history information for that specific investment vehicle, such as AAPL, from data source 14 to e.g. cloud server 15. Cloud server 15 then analyzes the price history information according to a first set of five simple moving averages (SMA's), namely SMA1, SMA2, SMA3, SMA4, and SMA5.

The value of a given SMA at any point in time, either historical time, or in real time, is calculated by averaging the closing prices for the respective investment vehicle for the last specified number of days. For example, the current value of a 5-day SMA is determined by averaging the values of the closing price of that investment vehicle for the last 5 days. Such daily average values could as well be averages of the daily open, daily close, daily high, daily low, or any other definable value which can be assessed on a regular basis, such as daily. Similarly, one can build a corresponding trading system based on multiple weekly or monthly SMA's where “n” is at least 3.

Selection of such daily open, daily close, daily high, daily low, or other definable value may be limited by the information available from resource database 14. Database 14 can, as desired, be a plurality of databases, in which case the computer system selects a specific database according to the information required for a computation as matched with the information available from a particular database. On the other hand, database 14 can be selected by the system manager/operator on the basis that such database contains all the information desired for use in making the desired calculations. Where a manager/operator of the system desires to expand the universe of investment vehicles beyond what is available from a given database, additional databases can be selected and accessed as desired.

Each SMA is assigned a number of “days”, meaning the number of consecutive days of closing price which must be averaged to arrive at a value for that SMA. Separately, each SMA is identified with a number “n” which is neutral to the number of days which are averaged to identify a value for that particular SMA. Restated, each of SMA1, SMA2, SMA3, SMA4, and SMA5 is represented by a number n, and is separately represented by the number of days which are averaged to determine the value of that particular SMA. Thus, e.g. SMA3 can be identified as a 5-day SMA, a 10-day SMA, a 200-day SMA, or any other number of days, but always retains its identity as SMA3.

The calculations contemplated in the invention can be performed with SMA's where any number of days can be assigned to any of the five SMA's. However, the methods of the invention are focused such that, in a typical preferred set of SMA's, in general a lower SMA number is associated with a relatively lower number of days which are being averaged and a higher SMA number is associated with a relatively greater number of days which are being averaged.

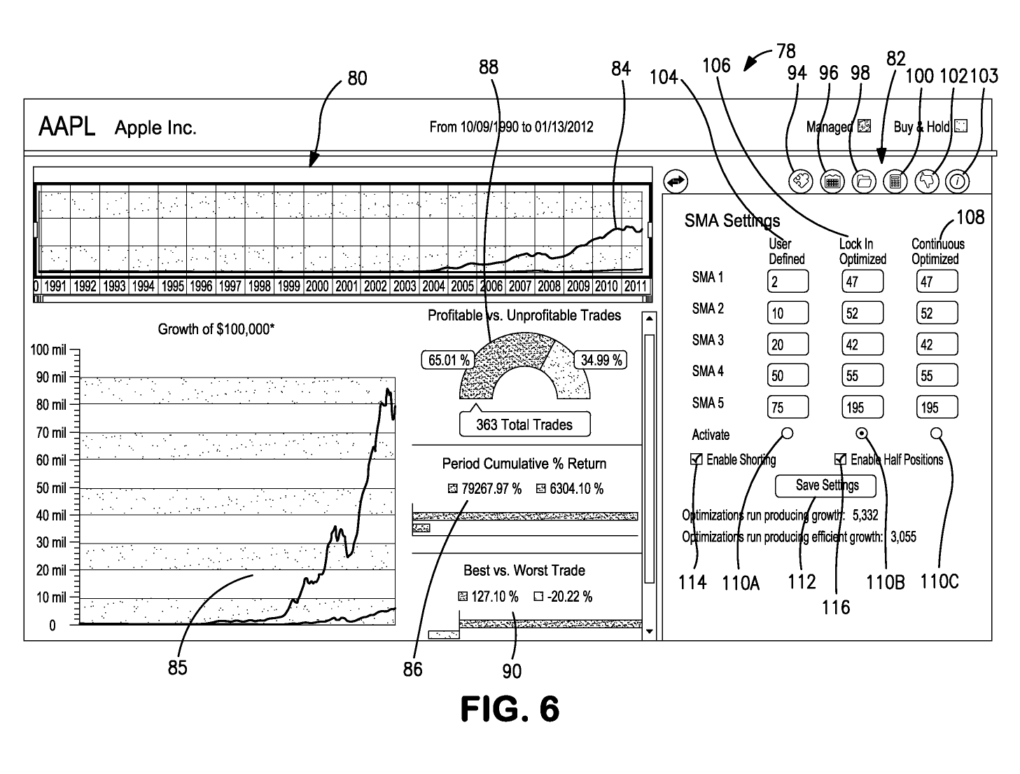

For example, FIG. 6 shows a “user defined” set of SMA's as follows:

| | |
|---|---|
| SMA1 | 2 |
| SMA2 | 10 |
| SMA3 | 20 |
| SMA4 | 50 |
| SMA5 | 75 |

FIG. 6 also shows a “Locked In Optimized” set of preferred SMA's as follows:

| | |
|---|---|
| SMA1 | 47 |
| SMA2 | 52 |
| SMA3 | 42 |
| SMA4 | 55 |
| SMA5 | 195 |

By “preferred” set of SMA's is meant that, up to a referenced time, the set of SMA's designated as “then-current preferred” is the best set of SMA's that has been found so far, when considering only cumulative return on investment, although other factors could be included in such determination of “preferred”.

In the above example, in the “User Defined” set of SMA's, the number of days constantly increases, but in the “Locked In Optimized” set, while the number of days generally increases from SMA1 to SMA5, the number of days actually decreases from SMA2 to SMA3.

The number of days assigned to each of the 5 SMA's can be any number for which price data is available. In general, the number of days is between 2 days and 500 days, optionally between 2 days and 200 days, although fewer than 200 days can be used as the upper system limit, such as 50 days, 75 days, 100 days, or 150 days. Of course, the fewer the number of days available for use in the SMA set, the smaller the universe of potential SMA sets which can be used in testing for an efficient, effective, SMA set.

The period of time represented by the data available on a given database can be limited by the information retained, accessed, by the database operator. In the alternative, in the case of investment vehicles which have a relatively shorter actual history, such as investment vehicles which recently underwent an Initial Public Offering, the period of time for which data is available for that investment vehicle will be no greater than the time the investment vehicle was publicly available, or the like. In such case, where the period of time where the data is available is shorter than the range of days for which a given SMA can be selected, the system limits the range of days for which a given SMA can be selected.

For example, when an investment vehicle is selected by a user, the computer automatically queries the database to determine how many days of data are available before selecting the SMA set, and limits the SMA selection to no more than the number of days of data that are available. If the system parameters are set, e.g. by the system manager/operator to select SMA's from 2 to 200 days, and only 100 days of data is available for a given investment vehicle, then the SMA selection is limited to SMA's representing no more than 100 days of data.

The method recognizes that future short term performance of a given investment vehicle is likely to be a continuation of recent performance, and yet the trading strategy needs to be sensitive to changes in overall market direction. Accordingly, the analysis first looks at market direction using two SMA factors, namely SMA3 and SMA4. The analysis compares relative values of SMA3 and SMA4. The relative value of SMA3 vs SMA4 is then used to focus the second factor of the analysis.

In beginning an analysis of a respective investment vehicle, the computer back tests the performance of an investment in that respective investment vehicle (e.g. AAPL) to determine a first value for cumulative return, and corresponding other trading results, namely to establish a starting point for the analysis, using the five SMA's, according to the following if/then SMA formula:

a. If value of SMA 3>value of SMA 4, then
If value of SMA2>value of SMA4 and value of SMA3>value of SMA5 then buy 1,
If value of SMA2<value of SMA4 and value of SMA3>value of SMA5 then buy ½,
If value of SMA2>value of SMA4 and value of SMA3<value of SMA5 then buy ½,
If value of SMA2<value of SMA4 and value of SMA3<value of SMA5 then go to cash,

b. If value of SMA 3<value of SMA 4, then
If value of SMA1<value of SMA3 and value of SMA2<value of SMA4 then short −1,
If value of SMA1>value of SMA3 and value of SMA2<value of SMA4 then buy ½.
If value of SMA1>value of SMA3 and value of SMA2>value of SMA4 then buy 1,
If value of SMA1<value of SMA3 and value of SMA2>value of SMA4 then go to cash.

The computer identifies a transaction signal at any historical time the calculation produces a change in the “action” step of “buy 1” “cash”, or “short”. During a back testing calculation, the computer simply records a hypothetical historical transaction signal, and corresponding transaction, any time an action step is identified, and the computation proceeds with the assumption that that action had been executed.

The action step “buy 1” means to buy the respective investment vehicle in a quantity represented by a predetermined value/cost of an investment.

The action step “½” buy means to buy the respective investment vehicle in a quantity represented by ½ of the predetermined value/cost of an investment.

The action step “cash” means to close out any position in the respective investment vehicle, whether a long position or a short position.

The action step “short 1” means to sell short the respective investment vehicle in a quantity represented by the predetermined value/cost of an investment. In addition, the action step “short 1” includes the action of selling any long position currently being held in the respective investment vehicle.

In the alternative, an action step “buy ½” or “buy 1” can be implemented with respect to a percentage of the respective portfolio. Thus, where the user determines to use five investment vehicles, equally weighted, in the portfolio, a transaction signal “buy 1” means buy an amount of the respective investment vehicle corresponding to ⅕ of the value of the portfolio, or a proportionate share of the cash available, or all of the cash available, whichever is less.

Once cloud computer 15 has computed a first value for cumulative return using the first set of 5 SMA's, the computer stores that value, and all corresponding relevant results in electronic memory as suggested at 46 in FIG. 2A.

In the next step, 5 SMA's are newly-selected by assigning a number of days to each SMA, thus creating a second set of SMA's, numbered “n”=1-5, where the number of days represented by at least one SMA in the second set of SMA's (1-5) is different from the number of days for that respective SMA (1-5) in the first set of SMA's. Again, any number of days can be associated with any one of the five SMA's.

Any method can be used for identifying the number of days which are associated with each of the newly-selected SMA's. In typical embodiments, a random selection process is used. As illustrated at 48 in FIG. 2A, such random selection can be performed by either user computer 12 or by cloud computer 15, by using known computer-based random selection methods.

Once the second set of SMA's has been selected by e.g. the cloud computer, the cloud computer again back tests the performance of an investment in that same investment vehicle (e.g. AAPL) to determine a second value for cumulative return, using the second set of five SMA's, according to the same formula, as illustrated at 50 in FIG. 2A.

At this point in the analysis, the cloud computer has a first set of results, including a first value for cumulative return on investment, from the first back test, generated using the first set of SMA's, and a second set of results, including a second value for cumulative return on investment, from the second back test, generated using the second set of SMA's.

As indicated at 52 in FIG. 2A, the cloud computer then performs a first comparison, comparing the first return on investment to the second return on investment, and selects the higher of the two cumulative returns, and saves the selected cumulative return as the “then-currently preferred” trading result, as well as saving the set of 5 SMA values which were used to calculate that trading result.

The value associated with a particular SMA is the number of days for which price of that investment vehicle is averaged to arrive at that particular SMA. For example, referring to FIG. 6, the SMA values might be

SMA1=47 days

SMA2=52 days

SMA3=42 days

SMA4=55 days

SMA5=195 days.

As indicated at 54 in FIG. 2A, the cloud computer then randomly selects a third set of SMA's, and performs a third back test of the same investment vehicle (AAPL), generating a third value for cumulative return. The cloud computer then compares the computed value for the third cumulative return with the saved “then-current preferred” trading result/cumulative return, selects the higher of those two cumulative returns, and saves the selected cumulative return as the “then-current” preferred” trading result, as well as saving the set of 5 SMA values which were used to calculate that “then-current preferred” trading result.

As indicated at 56 in FIG. 2A, the cloud computer then continues to repeat the steps of:
selecting a new set of SMA's,
back testing the newly-selected set of SMA's,
comparing the result of the back testing of the newly-selected set of SMA's with the “then-current preferred” trading result,
selecting the greater of the two cumulative returns,
saving the selected cumulative return as the “then-current preferred” trading result, and
saving the set of 5 SMA values which were used to calculate that “then-current preferred” trading result.

The cloud computer continues to repeat the above steps, thus running an initial set of iterations of the back testing and comparisons e.g. for 30 seconds, all using the same investment vehicle price information, and each time using a newly-randomly-selected set of SMA's. For each comparison, the cloud computer selects either the “then-current preferred” cumulative return, or the newly-calculated cumulative return, whichever is greater, as the new “then-current preferred” trading result. If the most recently calculated trading result is selected as the “then-current preferred” trading result, the trading result which had previously been designated as “then-currently preferred” is degraded from its preferred status and replaced by the most recently calculated trading result.

The initial set of iterations can be defined in terms of time, namely whatever number of iterations the computer can run in a given period of time. As a non-limiting alternative, the initial set of iterations can be defined in terms of a specified number of iterations, namely the computer continues running iterations until it has run the specified number of iterations, without regard to how long it takes to run that specified number of iterations.

Assuming, for example, that any number from 2 days to 200 days can be associated with each SMA, assuming five SMA's in each set, there are 198⁵ potential sets of SMA combinations which can be back tested.

As an illustration, where the computer continues to randomly select SMA's and SMA sets, and continues to back test such SMA sets without stopping, against e.g. 10 years or more of daily price information, a currently-available computer can back test about 50,000 to about 150,000 sets of simple moving averages per minute. So for a typical initial group of back tests on a newly-selected investment vehicle, the computer system can run an initial set of back test iterations for e.g. 30 seconds, testing about 25000-75000 sets of simple moving averages, each time comparing the results with the then-current preferred set of simple moving averages, and can display the then-current preferred/best results and the corresponding set of simple moving averages on computer 12.

As indicated at 58, after the specified initial set of iterations has been run, the computer system adds the specified investment vehicle to the list of investment vehicles displayed as part of the portfolio on user computer 12, for example the portfolio illustrated in FIG. 4 or 5. In addition, the computer system also calculates a variety of additional results which can be derived from the then-current data set in combination with the calculations already performed using the “then-current preferred” set of SMA's, including the most recent transaction signal.

As indicated at 60 in FIG. 2A, cloud computer 15 periodically repeats the process of:
selecting a new set of SMA's,
back testing the newly-selected set of SMA's,
comparing the result of the back testing of the newly-selected set of SMA's with the “then-current preferred” trading result,
selecting the greater of the two cumulative returns on investment,
saving the selected cumulative return on investment as the “then-current preferred” trading result, and
saving the set of SMA values which was used to calculate that “then-current preferred” trading result.

Any time cloud computer 15 replaces the “then-current preferred” trading result with a new “then-current preferred” trading result, the screen display information being sent to user computer 12 is updated.

As part of the updating procedure any time a new “then-current preferred” trading result is posted/saved, the transaction signal set is updated.

In the process of performing the back-testing, including the initial group of back tests performed on a newly-selected investment vehicle, the cloud computer generates a set of theoretical historical transaction signals which represent the transaction signals which would have been generated in historical time had the computer been running the respective back-testing in real time. The last, most recent, transaction signal in that set represents a current recommendation for the subject investment vehicle.

Once the initial group of back tests has been completed, the cloud computer continues to run additional back tests, with additional sets of randomly-selected SMA's, and replaces the “then-current preferred” trading result and SMA set with the new results, including displaying the new SMA set, any time a result is found which shows a greater cumulative return on investment than the existing “then-current preferred” trading result and SMA set.

The computer can generate two types of transaction signals. First, the computer can generate a transaction signal, which signifies that a transaction is currently indicated by the calculations. Second, by making a linear projection of the respective SMA's, the computer program can predict that an actual transaction signal will likely be triggered at identifiable future point in time. Accordingly, the program can generate a transaction alert signal any time a transaction signal is predicted to be generated within a specified number of days. Given the variability in price which can attend certain investment vehicles, the number of days of advance alert which is to be given is balanced against the reliability of the signal which is a function of volatility in price. If the alert time is too short, the user may not notice the alert and thus may not act at the appropriate time. If the alert time is too long, many investment vehicles will show an alert much of the time, and many of those alerts will change before a transaction signal is actually generated. An advance alert time period which has been found to be generally satisfactory is at least 3 days and up to about 20 days, A range of about 5 days to about 15 days optionally about 10 days, has been found to be satisfactory for many investment vehicles.

As indicated at 64 in FIG. 2A, periodically, such as daily, cloud computer 15 queries data source 14 and correspondingly downloads updated price information for the selected investment vehicle (AAPL), namely any price information which was generated since the computer last received an update. Thus, with a daily query, the computer already has all the historical price information except for that price information from the most recent day of trading. In such case, the change represented by the update is limited to the dividend and split-adjusted price information from the most recent day of trading. As another example, if the update query and information receipt is done e.g. weekly, the change represented by the update information includes all the dividend and split-adjusted price information relating to the trading during the last week.

Any time the cloud computer receives a data update, the computer compiles the new data with the previous data and employs the up-dated data set in subsequently-performed back testing on sets of SMA's. Any time the back testing produces a trading result having a greater return on investment than that provided by the then-current preferred set of SMA's, computer 15 sends update information and corresponding screen display information to user computer 12, where such displays are available to the user. If the back testing produces a transaction signal or a transaction alert signal, such signal is included in such update information and is posted as an alert in one or more of the screen displays which are available to the user at user computer 12.

Meantime, the cloud computer periodically continues the process of randomly selecting new sets of SMA's and performing back test calculations using those new sets of SMA's, using the most recent data set as most recently updated from the data source. To the extent a new set of SMA's produces a cumulative return superior to the cumulative return of the “then-current preferred” set of SMA's, the computer system replaces the existing “then-current preferred” set of SMA's with the new “then-current preferred” set of SMA's and its corresponding trading results. Included in the newly-calculated trading results are any current transaction signals or transaction alert signals.

As indicated at 66 in FIG. 2A, the user can select a second investment vehicle and instruct user computer 12 regarding performing back testing and showing the corresponding results. User computer 12 communicates such instruction to cloud computer 15 which then makes the data downloads and makes the initial set of calculations.

As indicated at 68 in FIG. 2A, cloud computer 15 repeats the data update downloads at specified periods of time, such as daily, and periodically selects and tests new sets of SMA's for each investment vehicle in, the portfolio.

As indicated at 70 in FIG. 2B, the user can continue to build the portfolio of investment vehicles which are being monitored by the trading system by selecting additional investment vehicles and instructing user computer 12 regarding performing back testing and adding such investment vehicles to the portfolio.

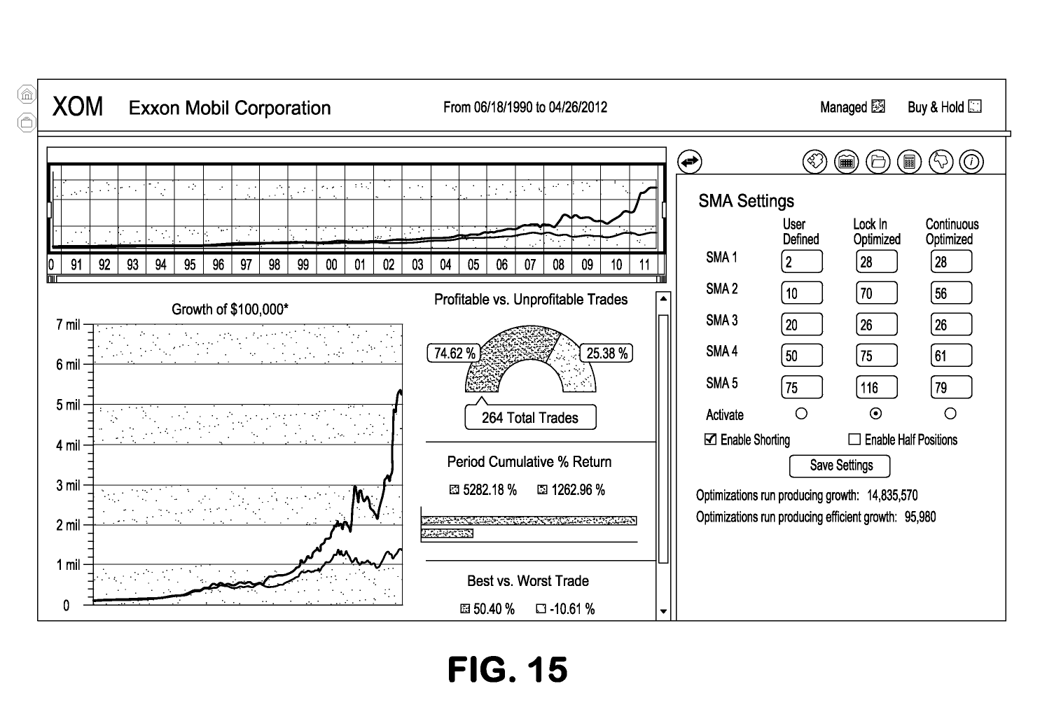

FIGS. 4 and 15 represent screen shots of the display at user computer 2. FIG. 4 illustrates, for example, part of a portfolio where a number of investment vehicles have been selected, and where the computer system has performed at least the initial back testing.

As indicated at 72 in FIG. 2B, the user may compare trading results for multiple investment vehicles in the portfolio and correspondingly identify those investment vehicles which will be used for real time investing using real financial assets. In so doing, the user can assign each investment vehicle to a group (FIG. 3). To assign an investment vehicle, already in the portfolio, to a group, and thereby move the investment vehicle to that group, the user first opens the group to which the investment vehicle is to be assigned, by activating the up-down link 74 associated with that group. The user then clicks on the line which represents the investment vehicle in the portfolio, holds the “shift” button down while dragging the line to the desired location in the open group, and drops the line at the desired location. An open such group, to which a number of investment vehicles has already been assigned, is illustrated in FIG. 4.

Referring to FIGS. 4 and 5, a more expanded version of the trading results for a particular investment vehicle is available to the user by activating expansion link 76 on the portfolio page. Activating the expansion link opens a new expansion window 78, illustrated generally in FIG. 6.

Expansion window 78 has a left side 80, and a right side 82 made visible by activating button 93. The left side of window 78 shows a value graph 84 representing hypothetical growth of an investment since inception, namely since the earliest date for which the computer has used price data for this investment vehicle. Left side 80 of the expansion window shows a second graph 85 representing the same value as in graph 84, but in shorter and taller presentation, thus emphasizing vertical divergences of the graph line.

Left side 80 also shows at 86, both numerically and as bar charts, the cumulative percent return on investment since inception, for an investment managed according to the invention and the same investment but using a buy and hold strategy.

Left side 80 also shows at 88, both numerically and in chart form, the percentage of profitable trades versus unprofitable trades for that same investment vehicle managed according to the invention, as well as showing the number of trades executed during the period shown in graph 84. In this context, profitable and unprofitable trades apply only where the possibility of making or losing money exists. Thus, a profitable or unprofitable trade can exist only when a long or short position is changed to a different position. Thus, a trade involves both a purchase transaction and a sale transaction.

Left side 80 also shows at 90, both numerically and in bar chart form, the gain or loss for each of the best and the worst trades being reported for the respective set of simple moving averages, using the methods of the invention as applied to the specific investment vehicle.

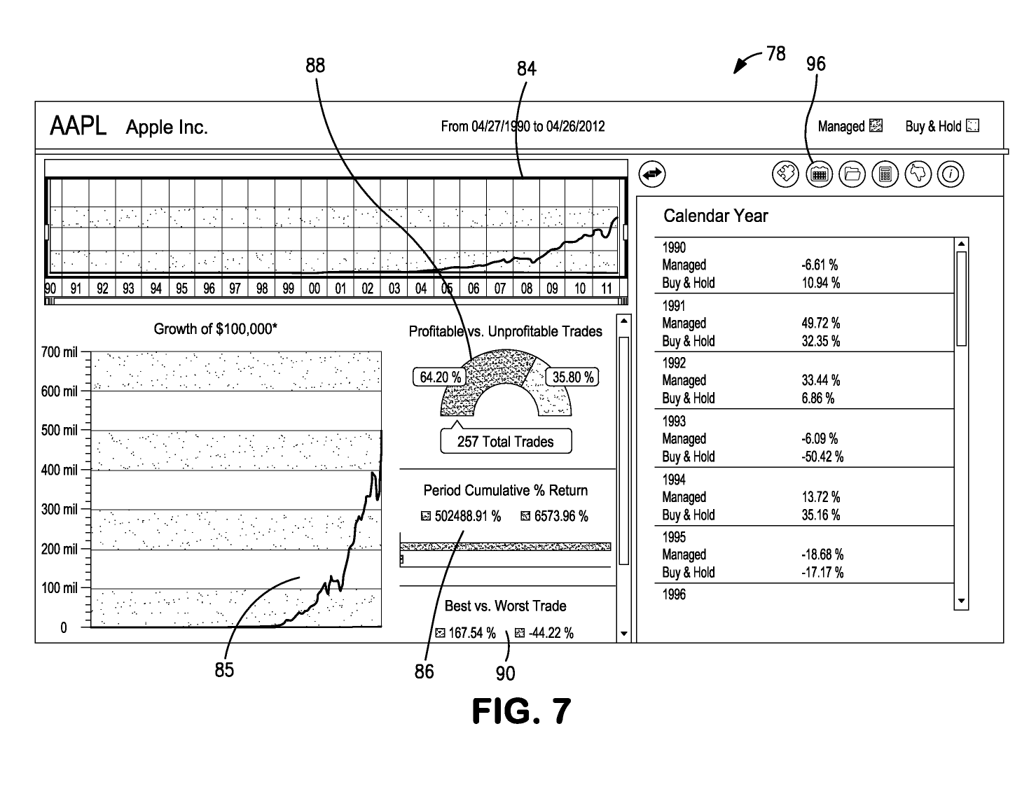

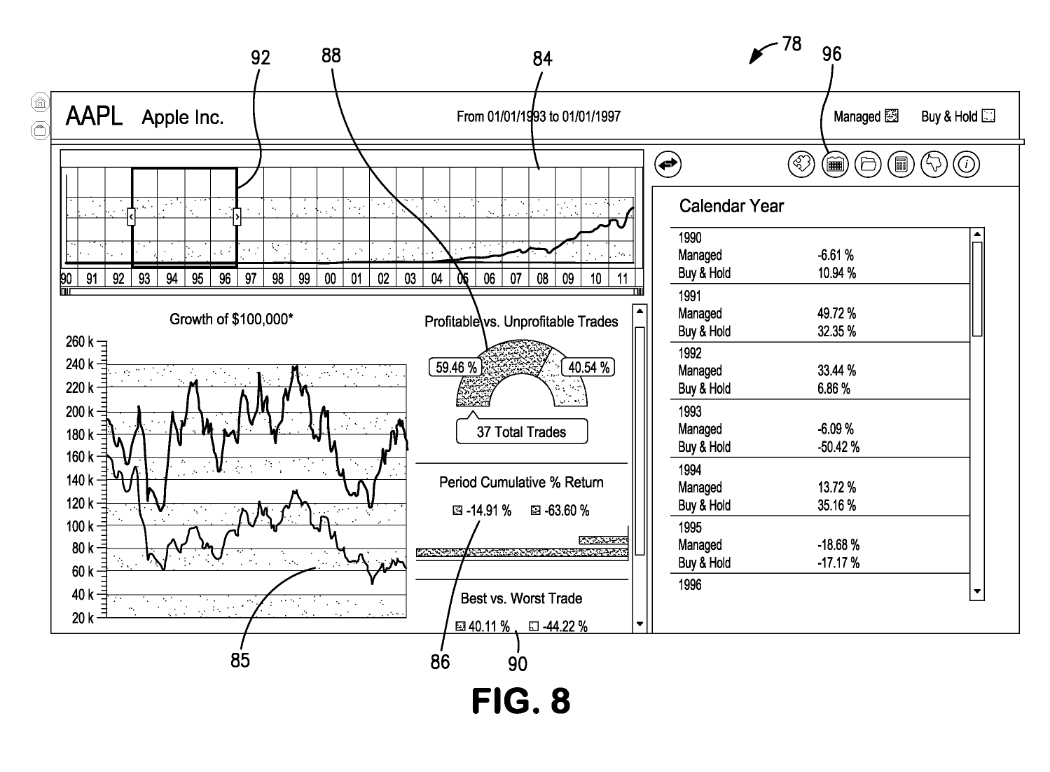

FIGS. 7 and 8 illustrate that a shorter period of time can be selected by the user, in graph 84. FIG. 7 illustrates the graph before selection. FIG. 8 illustrates left side 80 of the expansion window after such selection. Thus, FIG. 8 shows the period of time 92 in graph 84 which has been selected. Once the period of time 92 has been selected, the computer makes adjustments for the changed period of time, and displays the representations of those adjustments in graph 85, in the presentation of cumulative percent return 86, in the profitable versus unprofitable trades and the number of trades 88, and in the best and worst trades 90. The adjusted values can be seen by comparing such values in FIGS. 7 and 8.

Right side 82 of expansion window 78 provides the user with a number of options for displaying additional back testing and/or trading results information. In addition, right side 82 provides the user with a number of options for customizing the back testing process.

FIG. 6 illustrates the display options which can be selected, as well as the options for customizing the back testing process. Each of the display options can be activated by selecting a respective icon in the top portion of right side 82.

Icon 94 activates the display illustrated in FIG. 6, namely the SMA settings, along with user-activated selections which can affect the test results. Icon 96 activates a display which shows comparative results by calendar year. Icon 98 activates a display which shows the trade history as calculated by cloud computer 15. Icon 100 activates a display which shows trade efficiency. Icon 102 activates a display which shows maximum drawdown. Icon 103 activates a display which shows definitions, support links, help links, and the like. All of the information activated by icons 96, 98, 100, and 102 is specific to, derived from, a particular set of simple moving averages, as assessed with respect to a particular investment vehicle. Any time the set of simple moving averages is changed, the information reported through icons 96, 98, 100, 102 changes.

Returning to FIG. 6, right side 82 shows a User Defined set of SMA's 104, a Locked In Optimized set of SMA's 106, and a Continuous Optimized set of SMA's 108. The user can select any one of the three sets of SMA's, and obtain its back test results, by making a selection at buttons 110A, 110B, or 110C.

The User Defined SMA's represents a set of SMA's specifically determined, by the user and entered into the windows adjacent each of SMA1, SMA2, SMA3, SMA4, and SMA5.

The Continuous Optimized set of SMA's reflects the “then current preferred” set of SMA's as determined by the back testing performed by the computer up to the present time. Thus, the user has no input into the SMA's displayed in the column represented by the Continuous Optimized set of SMA's because, in the illustrated embodiments, the SMA's are randomly selected by the computer system 111. The computer system 111, as referred to herein, is the combination of cloud computer 15 plus at least one user computer 12. Computer 12 automatically displays the currently preferred set of SMA's in the Continuous Optimized column of SMA's any time icon 94 is active. When the Locked In set of SMA's is selected at 1108, user computer 12 shows the trade history based on the set of SMA's which is displayed in the Locked In Optimized column. Namely, the results displayed are graphs 84 and 85, Profitable vs Unprofitable Trades 88, Cumulative Return 86, Best vs Worst Trade 90, and all of the results displayed when icons 96, 98, 100, and 102 are activated.

When the User-Defined set of SMA's is selected at 110A, the windows beside each of SMA1, SMA2, SMA3, SMA4, SMA5 are activated such that the user can manually enter values for the respective SMA's. Once the new values have been entered, the user can select the Save Settings button 112, whereupon the computer re-calculates the trade history based on the User Defined SMA values.

When the user selects the Continuous Optimized set of SMA's, the computer recalculates the trade results and updates the displays the trade history based on the then-current preferred set of SMA's, namely graphs 84 and 85, Profitable vs Unprofitable Trades 88, Cumulative Return 86, Best vs Worst Trade 90, and all of the results displayed when icons 96, 98, 100, and 102 are activated.

When the Continuous Optimized set of SMA's has been selected, and the Locked In Optimized set of SMA's is subsequently selected at 110B, a query window opens, asking if the Locked In Optimized set of SMA's are to be overwritten with the Continuous Optimized set of SMA's illustrated in the Continuous Optimized set of SMA's. The user then selects “yes” or “no” or “cancel”, whereupon the set of SMA's then shown in the Locked In Optimized set of SMA's column is determined according to the user's answer to that question, and the computer displays the transaction history based on that set of SMA's selected, namely graphs 84 and 85, Profitable vs Unprofitable Trades 88, Cumulative Return 86, Best vs. Worst Trade 90. All of the results which are displayed when icons 96, 98, 100, and 102 are activated are also up-dated.

If the user says “no” to the overwrite question, then computer 12 displays the test results based on the existing Locked In Optimized set of SMA's.

If the user says “yes”, then the computer copies the Continuous Optimized set of SMA's to the Locked In Optimized column and displays the trade history accordingly.

If the user says “cancel”, then the computer continues to monitor the results for the Continuous Optimized set of SMA's and displays test results for whatever set of SMA's is displayed in the Continuous Optimized set of SMA's column.

In addition, the computer updates the set of SMA's in the Continuous Optimized set of SMA's any time the computer replaces the then-current preferred set of SMA's with a newly-discovered, newly preferred, set of SMA's which provides a cumulative return on investment superior to the cumulative return on investment calculated for the then-current preferred set of SMA's. Accordingly, the user can compare the SMA's in columns 106 and 108. Any difference in the two sets of SMA's is a signal to the user that the computer has discovered a new set of SMA's, shown in column 108, which provides a greater return on investment than the SMA set shown in Locked In Optimized column 106

Thus, the fact that the SMA sets are different in columns 106 and 108 is a signal to the user that the computer has identified a new set of SMA's which yields a cumulative return on investment greater than the cumulative return on investment for the now-shown set of SMA's in column 106. The user can compare the differences in the trade results by noting the trade information of interest with respect to the Locked In Optimized set of SMA's, then selecting column 108, and comparing the trade results of interest.

If desired, the user may lock in the Continuous Optimized set of SMA's in column 108 by selecting column 106 and answering “yes” when asked if the set of SMA's in column 106 should be overwritten. The computer then calculates and displays the test results for the SMA set in column 106, and subsequently continues the search for a set of SMA's which yields a yet greater cumulative return on investment. If/when the computer finds such greater return on investment, the computer displays the set of SMA's which provides such greater return on investment in the Continuous Optimized column.

In activating any of the above selections of SMA's, the user also has the option to enable or disable short sales as an element of the back testing by selecting or deselecting Enable Shorting button 114. The Enable Shorting button is shown selected in FIG. 6. In addition, the user can also enable or disable half positions as an element of the back testing by selecting or deselecting Half Positions button 116. With the Half Positions button selected, the computer will calculate the trade history with use of half positions as indicated in the calculations of the SMA formula. With Half Positions deselected, the computer will ignore all half position transaction signals and will not issue any transaction signal until a different transaction signal point is reached which triggers a full trade indicator, a cash indicator, or a short indicator.

FIG. 7 shows the right side 82 of expansion window 78 when Calendar Year icon 96 has been activated. As illustrated in FIG. 7, the overall trading result is expressed for each calendar year, both for a Buy and Hold strategy and for the managed strategy of the invention. Different time periods, other than a calendar year, could be specified in the software, and so displayed.

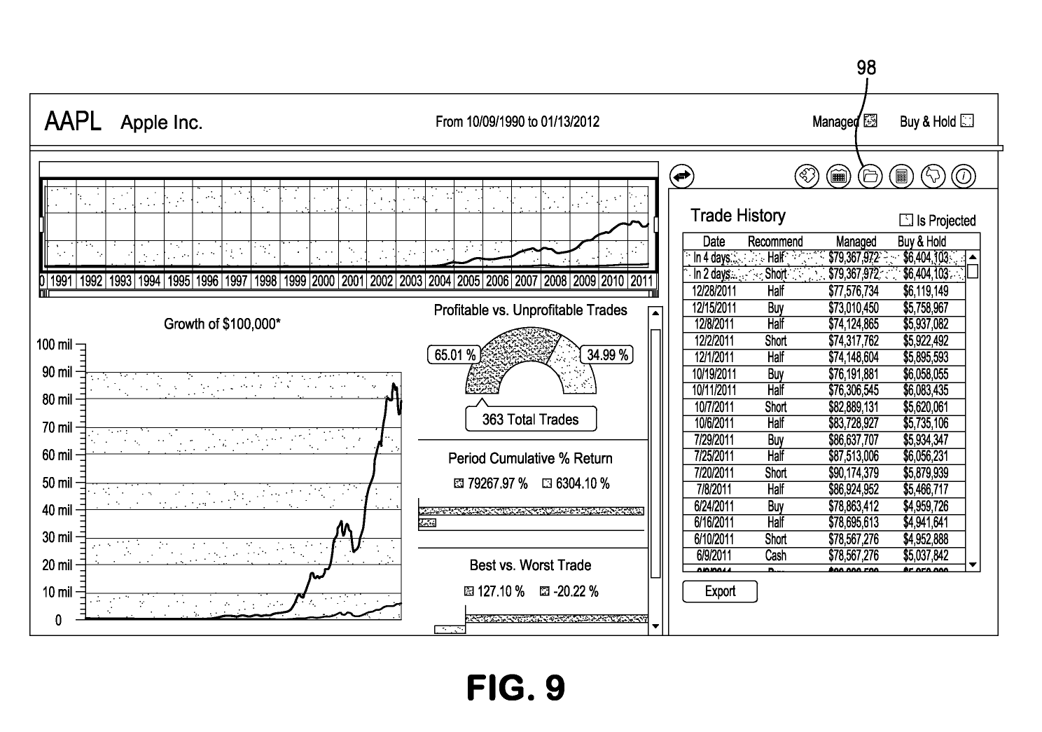

FIG. 9 shows the right side 82 of expansion window 78 when Trade History icon 98 has been activated. As illustrated in FIG. 9, each transaction signal is illustrated as a trade. Each trade is represented by a single trade line. Each trade line shows the date of the transaction, the type of trade, whether Buy, Half, Cash, or Short, and the cumulative value of a holding of the Investment Vehicle which started with $100,000 at initiation of the Trade History, when managed according to the invention. In addition, each line shows the cumulative value of the same investment vehicle using a Buy and Hold strategy. The lines, taken in sequence, show the chronological history of use of the managed methods of the invention with respect to the respective investment vehicle.

If any transaction signals are current, or if future transaction signals are anticipated near term, such current or near-term future transaction signals are shown shaded at the top of the Trade History, including the number of days, if any, to expected generation of actual transaction signals, as designated at 117.

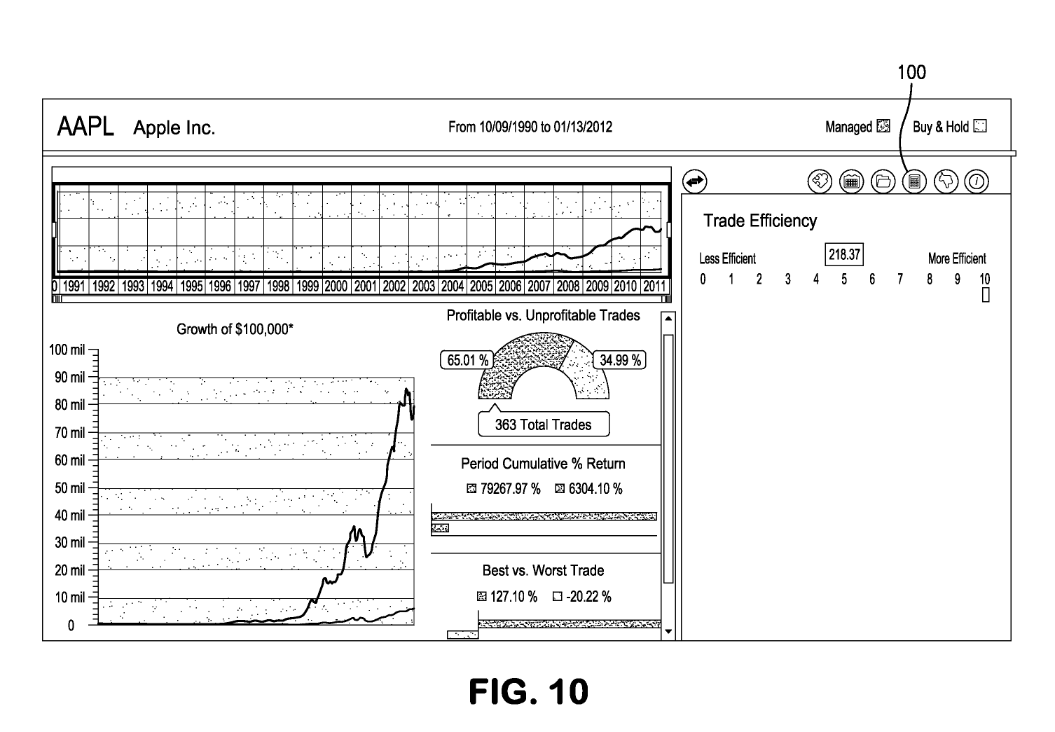

FIG. 10 shows the right side of window 82 of expansion window 78 when Trade Efficiency icon 100 is selected. Trade efficiency, as represented in FIG. 10, indicates the average percent gain, or loss, for each set of buy/sell transactions which entered, and subsequently exited, a trade, according to the back tested trade history using the SMA formula and the selected SMA set. A line chart shows a trade efficiency of “0” as being relatively less efficient, and a trade efficiency of “10” as being relatively more efficient. By comparison, the actual trade efficiency shown in FIG. 10 is 218.37, which represents an extremely efficient set of trades.

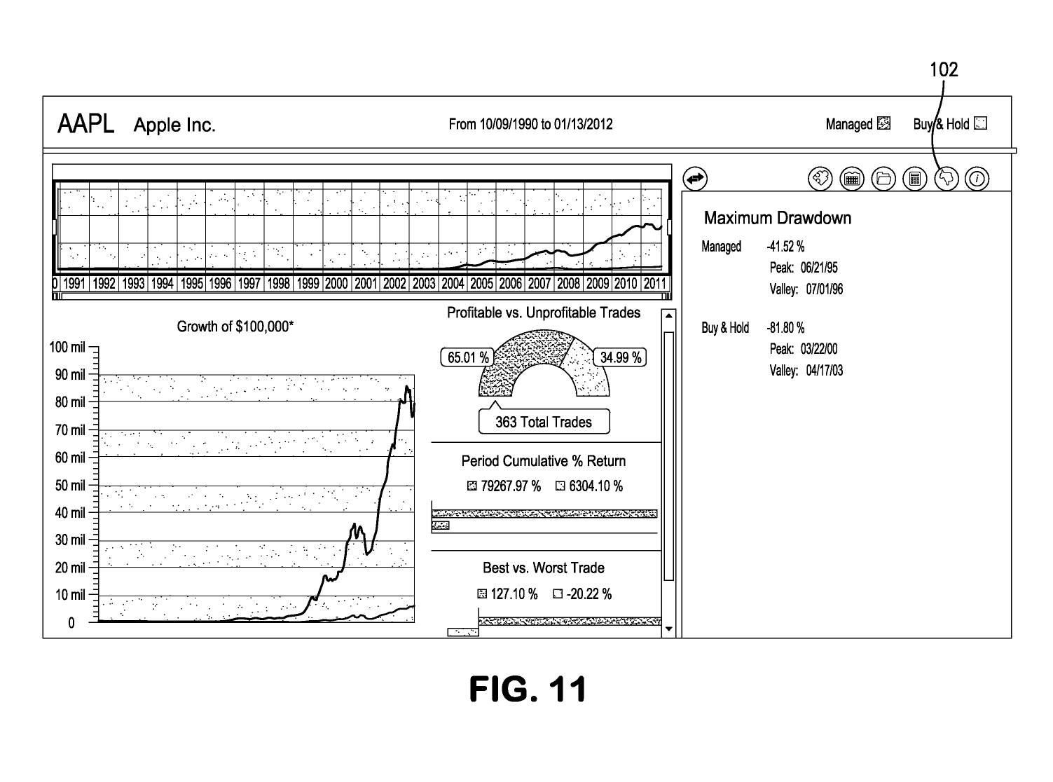

FIG. 11 shows the right side of window 82 of expansion window 78 when Maximum Drawdown icon 102 is selected. Maximum drawdown, as represented in FIG. 11, indicates the maximum paper loss, from peak value to trough, at any time during the period of time selected in the window activated by icon 94, SMA Settings. Maximum drawdown is shown both for managed trading according to the invention using the SMA formula, and for a Buy and Hold strategy.

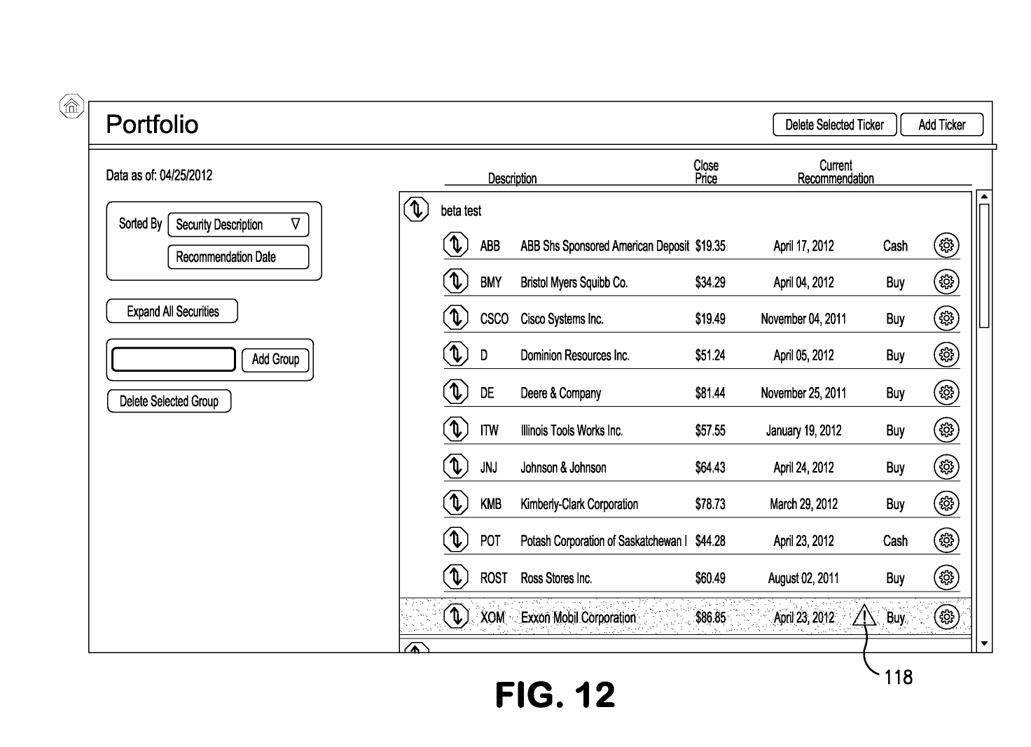

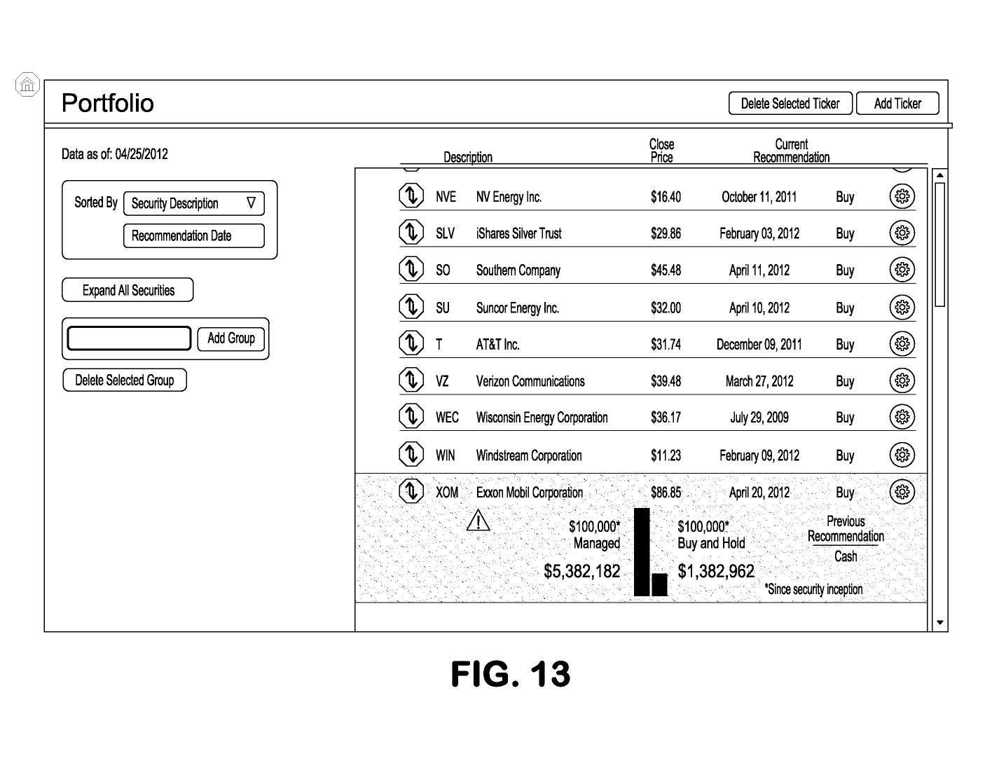

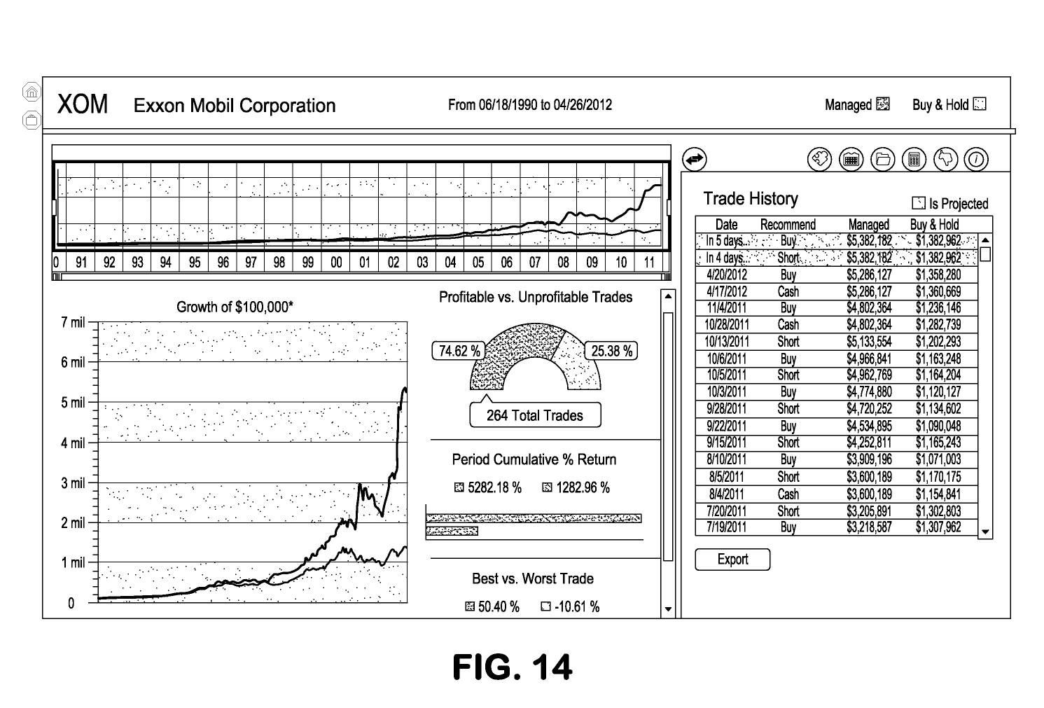

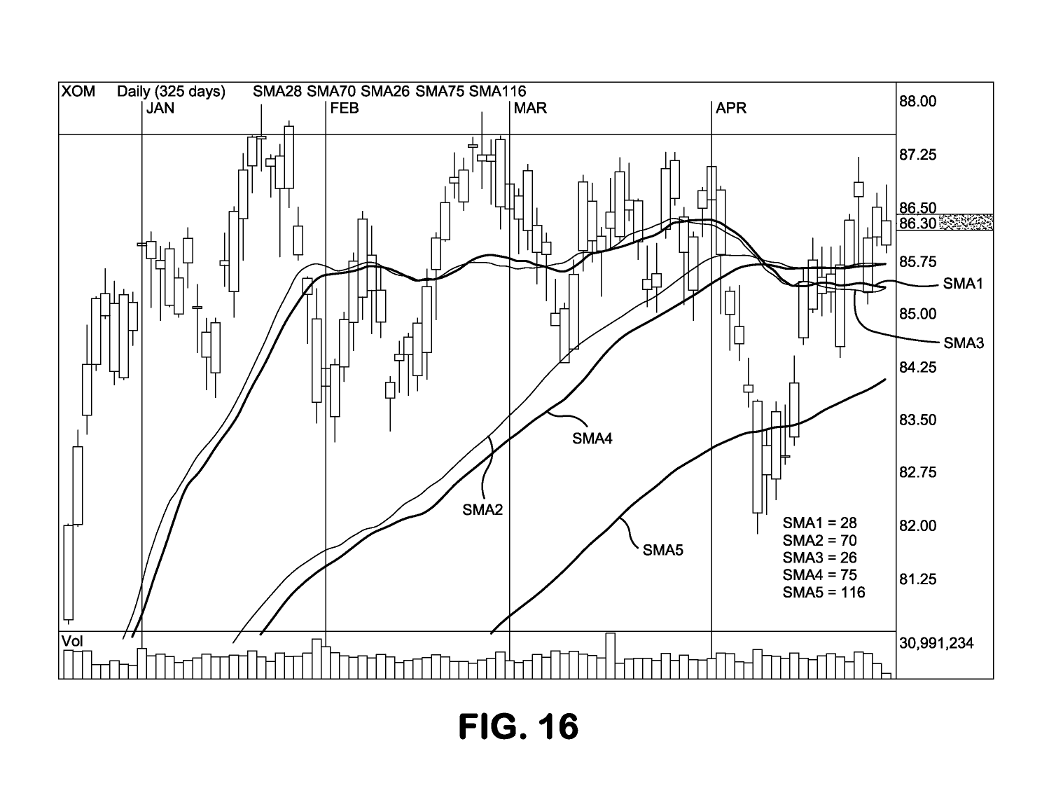

FIG. 12 shows a portfolio window as in FIG. 4, but showing an anticipated transaction signal 118 as an outline of a triangle, containing an exclamation point between the date and the indicated action for investment vehicle XOM. Thus, upon opening the portfolio window, the user is alerted to an anticipated transaction signal for the respective investment vehicle. FIG. 13 shows the same anticipated transaction signal in a different location on the investment vehicle line, but in the expanded version of the investment vehicle line. FIG. 14 shows that same anticipated transaction signal for XOM as two anticipated signals in the Trade History window, namely a Short transaction in 4 days followed by a Buy transaction a day later, at 5 days from the current date. FIG. 15 shows the SMA Settings window for that same representation of trade history and anticipated transaction signals. FIG. 16 shows a graphical representation of daily price history for the same time period, including the set of SMA's indicated in FIG. 15 for the Locked in Optimized set of SMA's. FIG. 16 illustrates how the respective simple moving averages can generate frequent and/or multiple transaction signals, or at least anticipated transaction signals when the triggering simple moving averages are progressing along nearly parallel paths.

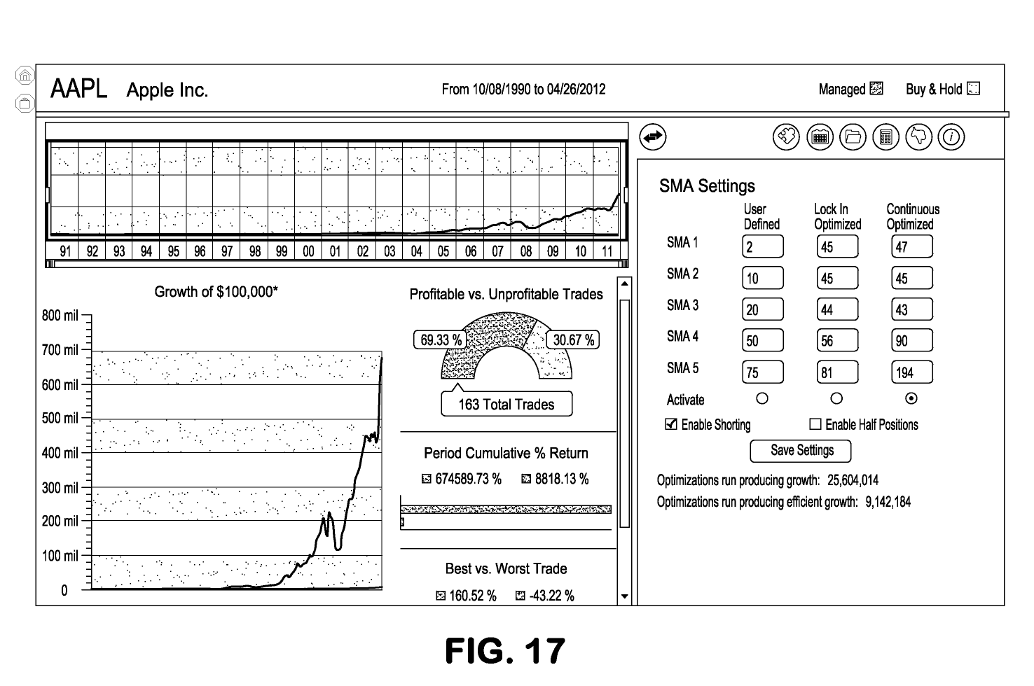

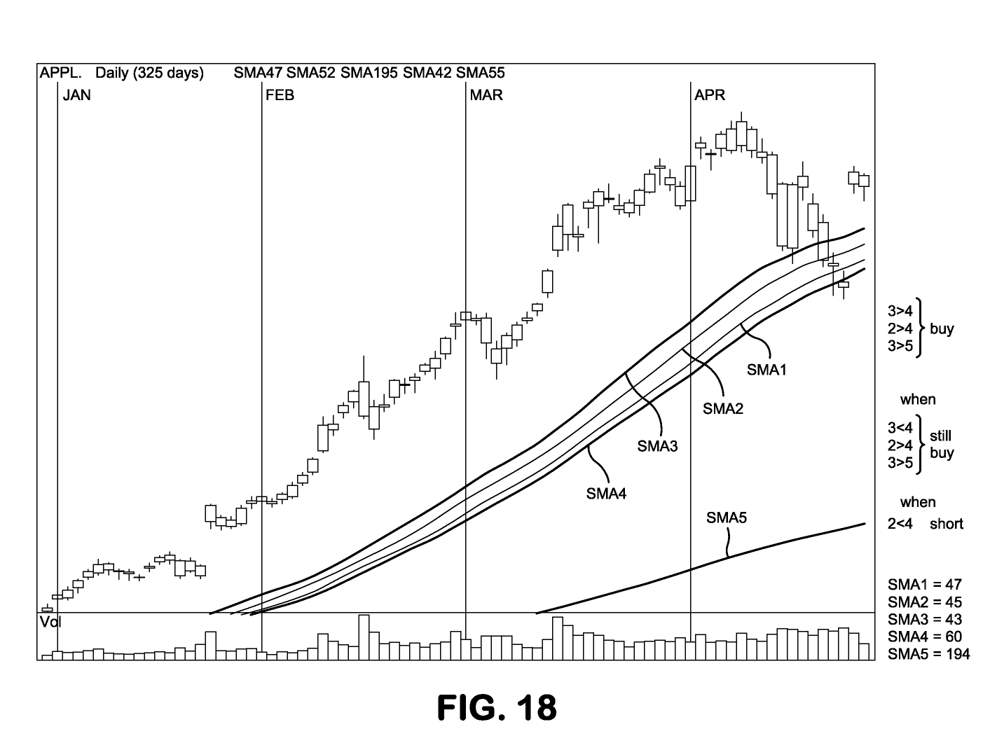

By contrast, FIGS. 17 and 18 illustrate how a set of simple moving averages can represent a substantial calculated period of time without generating any transaction signals in a strong price trend. Such strong price trend may be a rising price trend as illustrated in FIGS. 17 and 18, or may be a declining price trend.

The data processing capability/functionality of the invention, as described herein can be installed on any computer system configuration which is compatible with receiving the necessary software to perform the methods/functions of the invention. Namely, the system has to be able to communicate with a user, to download market price information, and to make the necessary calculations. Applicant contemplates that, in many implementations, the system will provide the user with at least some of the screen views described herein on a computer-type screen.

As used herein, computer-type screen means any pixel-based or screen, or any screen which has a graphics/image-based output that can show the types of images represented in the drawings herein. Examples of computer-type screens available on current products are those on personal computers, on portable computers, on tablet computers, on netbook computers, on smart phones, and the like.

Thus, especially the portion of the system of the invention which communicates directly with a user can be any device capable of handling the computational requirements of user computer 12 in order to satisfy the communications to and from the user as described herein. Thus, user computer 12 represents a wide variety of devices including, without limitation, desk-type personal computers, devices that are currently referred to as portable computers, tablet computers, netbook computers, smart phones, computers/phones which blur the line between smart phones and the smallest consumer-available personal computational devices. The common feature of all such devices is the capacity for the user to have both input and output capability, as well as the capacity for the device to communicate, through some network, with the cloud server computer.

Where elements of the “system”, namely the user computer 12 and cloud server 15, are disposed at more than one location, communication between the system elements can be by any available means. Thus, the communication can be all through hard wired network, through all wireless network, or through a combination of hard wired network and wireless network.

The computation capacity represented in the invention has been illustrated as a computer system 111, which comprehends the combination of at least one user computer 12 and at least one cloud server computer 15. The benefits of having one or more cloud server computer 15 is that the server provides centralized capability to communicate with, and perform calculations for, multiple users, using collective use demand to efficiently process the demands received from multiple users, as well as to share its computational results with multiple users.

The benefit of the user computer is to provide a dedicated user interface into the back-testing system provided by computer 15. In addition, the server computer/user computer combination allows the server to “serve” multiple users from a single asset base.

Thus, the bi-level computer system 111 as represented in FIG. 1 is designed to provide computational efficiency at the server/cloud level of computer 15 while providing the individual attention/service at the user computer level of computer 12.

In the two-level computer system illustrated herein, user computer 12 provides such functions as:
Receive all user input, including
   Identifying and selecting groups,
   Selecting investment vehicles,
   Selecting all manual inputs for back-testing a particular investment vehicle, and
   Controlling the user's interface with the collective computer system;
Communicates appropriate user input to the cloud computer;
Receives test results, including current transaction signals, from the cloud computer;
   Displays test results;

The cloud computer provides such functions as:
Receives user input from the user computer, including receiving investment vehicle selections;
Accesses a resource database;
Retrieves price information from the resource database;
Selects SMA sets where indicated, allowed by a user;
Performs back testing using the selected SMA sets;
Stores the best 100 test results, along with the associated SMS sets;
Shares back test results among all querying users; and
Communicates test results with querying user computers.

Thus, user computer 12 is focused on providing an interface between the user and the trading system of the invention.

Cloud server computer 15 is focused on performing calculations, creating reports regarding such calculations, and interfacing with multiple users through corresponding multiple user computers.

Communications between computers 12 and 15 is typically, though not necessarily, conducted using an internet interface.

While the computer system has been illustrated using computers at two levels, the system is susceptible to being used as a one-level computer system where users are connected to the computer system by terminals having only limited computing capacity. The system can also be used as a single-level, peer-to-peer, system where computing tasks may be shared among the various user computers, and computed results are shared peer-to-peer.

Although the invention has been described with respect to various embodiments, it should be realized this invention is also capable of a wide variety of further and other embodiments within the spirit and scope of the appended claims.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

1. A method of making investment transaction decisions, comprising:
(a) selecting an investment vehicle;
(b) downloading, from a resource database, historical price data for the selected investment vehicle, for a selected time period;
(c) employing a first set of “n” simple moving averages, represented by “SMA1 SMA2, SMA3 . . . ”, where “n” is at least 3, back testing, by calculations, simple moving average crosses using the first set of simple moving averages and a set of criteria to trigger transaction signals regarding theoretical historical transactions, thereby generating a first set of theoretical historical transaction data and dates, and corresponding first theoretical managed trading results over a defined past period of time, and storing the first trading results in electronic memory;
(d) selecting a second different set of “n” simple moving averages designated by the digits “SMA1, SMA2, SMA3 . . . ”, where “n” is at least 3;
(e) repeating the back testing using the second set of simple moving averages and the same set of criteria and thereby generating a second set of theoretical historical transaction data and dates, and corresponding second theoretical managed trading results, over the same defined past period of time;
(f) comparing the second back-tested theoretical managed trading results to the first back-tested theoretical managed trading results and, based on the compared results, determining which of the first and second sets of SMA's produces a greater return on investment and is thus a then-current preferred set of simple moving averages;
(g) retaining in memory, as the then-current preferred set of simple moving averages, that one of the first and second sets of simple moving averages which produced the greater return on investment;
(h) periodically back testing additional sets of “n” simple moving averages, and thereby developing an ongoing stream of theoretical managed trading results;
(i) after each such back test, comparing the newly-developed trading results with the trading results from the existing preferred set of simple moving averages and thereby determining a new then-current preferred set of simple moving averages;
(j) retaining the new then-current preferred set of simple moving averages in memory as the existing preferred set of simple moving averages; and
(k) after obtaining the second or subsequent back test results, making transaction decisions based on the back testing, including transaction signals recently generated using the then-current preferred set of simple moving averages.

2. A method as in claim 1, further comprising using a random selection process to randomly select each of the simple moving averages in the second set of simple moving averages.

3. A method as in claim 1, further comprising using a random selection process to randomly select each of the simple moving averages in each of the sets of simple moving averages, optionally less one set of simple moving averages.

4. A method as in claim 1, further comprising generating a computer-type screen display which represents the fraction of the transaction signal combinations which produced profitable trades.

5. A method as in claim 1, further comprising generating a computer-type screen display which represents cumulative return based on transactions executed according to the transaction signals, as well as cumulative return based on a buy and hold strategy.

6. A method as in claim 1, further comprising providing a computer-type screen display having an interactive computer interface which allows a user to select, for use in computing trading results, any of
(i) a manually specified set of simple moving averages,
(ii) a locked-in, previously-selected, preferred set of simple moving averages, or
(iii) a periodically-updated set of simple moving averages.

7. A method as in claim 1, further comprising providing a computer-type screen display, having an interactive computer interface which allows a user to enable or disable half positions, and/or to enable or disable short selling the investment vehicle, as screening criteria in calculating the back-test results.

8. A method as in claim 1, further comprising using a computer to calculate, as part of the back testing, the return on investment using the then-current preferred set of simple moving averages, and corresponding trading results using a buy and hold strategy over individual periods of time, within the selected time period and shorter than the selected time period.

9. A method as in claim 1, further comprising providing an interactive computer interface which enables a user to specify a shorter period of time, within the selected time period, or to specify the entire selected period of time, and to command a computer to calculate overall cumulative return for the specified period of time, as well as optionally calculating the fraction of the transaction signal combinations which theoretically produced profitable trades, using the then-current preferred set of simple moving averages.

10. A method as in claim 9, further comprising providing a computer-type screen display of hypothetical growth of an investment over the selected period of time or the shorter period of time, whichever is specified by the user, representing a managed trading strategy and a buy and hold strategy.

11. A method as in claim 1, further comprising providing a computer-type screen display which shows each transaction as signaled by the back-testing process, including
(i) transaction date,
(ii) transaction action taken, and
(iii) accumulated value of an investment as of the transaction date,
using the then-current preferred set of simple moving averages.

12. A method as in claim 1, further comprising providing a computer-type screen display which shows average trade efficiency for an investment vehicle using the then-current preferred set of simple moving averages, over the selected time period.

13. A method as in claim 1, further comprising calculating and storing in non-temporary memory, maximum drawdown for the selected investment vehicle, and providing a computer-type screen display which shows such maximum drawdown.

14. A method as in claim 1 wherein “n” is at least 5.

15. A method as in claim 1, further comprising periodically updating the historical price data, from such resource database, to reflect current market information, and using the updated data in subsequently-performed back testing, and corresponding selection of the then-current preferred set of simple moving averages, each time using a newly-selected set of simple moving averages, and by using results of such subsequently-performed back testing, generating additional transaction signals as consistent with the set of criteria.

16. A method as in claim 15 wherein the calculations are performed by a computer and wherein, upon generation of a real time such transaction signal, the computer sends a communication to a market platform where the respective investment vehicle can be purchased and/or sold, and places a transaction order based on such real time transaction signal.

17. A method as in claim 1, further comprising updating and compiling the historical price data to memory at predetermined spaced time intervals.

18. A method of making investment transaction decisions, comprising:
(a) selecting a first investment vehicle;
(b) downloading, from a resource database, historical price information for the first selected investment vehicle, for a selected period of time;
(c) employing multiple first sets of “n” simple moving averages, each such first set of “n” simple moving averages being represented by “SMA1, SMA2, SMA3 . . . ,” where “n” is at least 3, back testing the first investment vehicle using the multiple first sets of simple moving averages, and simple moving average crosses, according to a first set of criteria, using at least 200 days of price information with at least 500 such sets of simple moving averages, at a rate of at least 250 such sets of simple moving averages per minute, to determine a first set of hypothetical transaction signals and thereby obtaining first trading results for the selected period of time;
(d) selecting a second investment vehicle;
(e) downloading, from the resource database, historical price data for the second selected investment vehicle, for the selected period of time;
(f) employing multiple second sets of “n” simple moving averages, each such second set of “n” simple moving averages being represented by “SMA1, SMA2, SMA3 . . . ,” where “n” is at least 3, back testing the second investment vehicle using the multiple second sets of simple moving averages, and simple moving average crosses, according to the same first set of criteria, and using the same set of at least 200 days of price information with at least 500 such sets of simple moving averages, at a rate of at least 250 such sets of simple moving averages per minute, to determine a second set of hypothetical transaction signals and thereby obtaining second trading results for the selected period of time;
(g) as part of the back testing of each such investment vehicle, determining which of the simple moving average sets tested provides greatest overall trade efficiency for the respective selected investment vehicle, and selecting that respective set of simple moving averages as a then-current preferred set of simple moving averages; and
(h) using the determined trade efficiency as at least one selection factor, selecting one or more of the investment vehicles so back tested as transaction candidates.

19. A method as in claim 18, further comprising using a computer to randomly select the simple moving averages in at least one of the sets of simple moving averages used in back testing each of the first and second investment vehicles.

20. A method as in claim 18, further comprising generating a computer-type screen display for at least one of the selected investment vehicles which represents the fraction of the transaction signal combinations which produced profitable trades.

21. A method as in claim 18, further comprising generating a computer-type screen display which represents cumulative return on investment based on trades made according to the transaction signals, as well as cumulative return on investment based on a buy and hold strategy.

22. A method as in claim 18, further comprising providing a computer-type screen display having an interactive computer interface which allows a user to select, for use in calculating trading results, any one of
(i) a manually specified set of simple moving averages,
(ii) a locked-in, previously-selected preferred set of simple moving averages,
(iii) a periodically-updated set of simple moving averages.

23. A method as in claim 18, further comprising using a computer to calculate, as part of the back testing, the return on investment using the so determined simple moving average set for the respective investment vehicle, and results using a buy and hold strategy, within the selected period of time.

24. A method as in claim 18, further comprising providing a computer-type screen display which shows each such hypothetical transaction as signaled by the back-testing process, including
(i) transaction date,
(ii) transaction action taken, and
(iii) accumulated value of an investment vehicle as of the transaction date,
using the current set of simple moving averages.

25. A method as in claim 18, further comprising calculating, and storing in non-temporary memory, maximum drawdown for the selected investment vehicle, and providing a computer-type screen display which shows such maximum drawdown.

26. A method as in claim 19 wherein “n” is at least 5.

27. A method as in claim 26, further comprising periodically updating the historical price data to a computer, to reflect current market information, and using the computer and the updated data to subsequently perform back testing, and corresponding selection of the then-current preferred set of simple moving averages, each time using a newly-randomly-selected set of simple moving averages, and by using results of such subsequently-performed back testing, generating additional transaction signals, including real time transaction signals.

28. A method as in claim 27 wherein, upon generation of a real time such transaction signal, the computer sends a communication to a market platform where the respective investment vehicle can be purchased and/or sold, and automatically places a transaction order based on such real time transaction signal.

29. A method of making investment transaction decisions, comprising:
(a) selecting a first investment vehicle;
(b) downloading, from a resource database, historical price information for the first selected investment vehicle, for a selected period of time;
(c) employing multiple first sets of simple moving averages, each such first set of “n” simple moving averages being represented by “SMA1, SMA2, SMA3 . . . ,” where “n” is at least 3, back testing the first investment vehicle using the multiple first sets of simple moving averages, and simple moving average crosses, according to a first set of criteria, using at least 200 days of price information with at least 500 such sets of simple moving averages, at a rate of at least 250 such sets of simple moving averages per minute, to determine a first set of hypothetical transaction signals and thereby obtaining first trading results for the selected period of time;
(d) selecting a second investment vehicle;
(e) downloading, from the resource database, historical price information for the second selected investment vehicle, for the selected period of time;
(f) employing multiple second sets of “n” simple moving averages, each such second set of “n” simple moving averages being represented by “SMA1, SMA2, SMA3 . . . ,” where “n” is at least 3, back testing the second investment vehicle using the multiple second sets of simple moving averages, and simple moving average crosses, according to the same first set of criteria, and using the same at least 20 days of price information with at least 500 such sets of simple moving averages, at a rate of at least 250 such sets of simple moving averages per minute, to specify a second set of hypothetical transaction signals and thereby obtaining second trading results for the selected period of time;
(g) as part of the back testing of each such investment vehicle, determining which of the simple moving averages provides greatest return on investment for that investment vehicle, calculating maximum draw-down of value for that investment vehicle, from peak to valley, and selecting, as the then-current preferred set of simple moving averages, that one set of simple moving averages which produces the greatest return on investment; and
(h) using maximum draw-down as at least one selection factor, selecting one or more of the investment vehicles so back tested as transaction candidates.

30. A method as in claim 29, further comprising using a random selection process to randomly select the simple moving averages in at least one of the sets of simple moving averages used in back testing each of the first and second investment vehicles.

31. A method as in claim 29, further comprising generating a computer-type screen display for at least one of the selected investment vehicles which represents the fraction of the transaction signals which produced profitable trades.

32. A method as in claim 29, further comprising generating a computer-type screen display which represents cumulative return on investment based on trades made according to the transaction signals, as well as cumulative return on investment based on a buy and hold strategy.

33. A method as in claim 29, further comprising providing a computer-type screen display having an interactive computer interface which allows a user to select, for use in calculating trading results, any one of
(i) a manually specified set of simple moving averages,
(ii) a locked-in, previously-selected, preferred set of simple moving averages, or
(iii) a periodically-updated set of simple moving averages.

34. A method as in claim 29, further comprising using a computer to calculate, as part of the back testing, the return on investment using the so determined simple moving average set, and results using a buy and hold strategy, within the selected period of time.

35. A method as in claim 29, further comprising providing a computer-type screen display which shows each such hypothetical transaction as signaled by the back-testing process, including
(i) transaction date,
(ii) transaction action taken, and
(iii) accumulated value of an investment as of the transaction date,
using the then-current preferred set of simple moving averages.

36. A method as in claim 29 wherein “n” is at least 5.

37. A method of making investment transaction decision, comprising:
(a) selecting a first investment vehicle;
(b) downloading, from a resource database, historical price information for the first selected investment vehicle, for a selected period of time;
(c) employing multiple first sets of simple moving averages, each such first set of “n” simple moving averages being represented by “SMA1, SMA2, SMA3 . . . ,” where “n” is at least 3, back testing the first investment vehicle using the multiple first sets of simple moving averages, and simple moving average crosses, according to a first set of criteria to determine a first set of hypothetical transaction signals and thereby obtaining first trading results for the selected period of time;
(d) selecting a second investment vehicle;
(e) downloading, from the resource database, historical price information for the second selected investment vehicle, for the selected period of time;
(f) employing multiple second sets of “n” simple moving averages, each such second set of “n” simple moving averages being represented by “SMA1, SMA2, SMA3 . . . ,” where “n” is at least 3,
back testing the second investment vehicle using the multiple second sets of simple moving averages, and simple moving average crosses, according to the same first set of criteria to specify a second set of hypothetical transaction signals and thereby obtaining second trading results for the selected period of time;
(g) as part of the back testing of each such investment vehicle, calculating the cumulative return on investment, within the database set; and
(h) using the cumulative return on investment as at least one factor, selecting one or more of the investment vehicles so back tested as a transaction candidate.

38. A method as in claim 37, further comprising using a random selection process to select the simple moving averages in at least one of the sets of simple moving averages used in back testing each of the first and second investment vehicles.

39. A method as in claim 37, further comprising generating a computer-type screen display for at least one of the selected investment vehicles, to represent the fraction of the transaction signal combinations which represent profitable trades.

40. A method as in claim 37, further comprising generating a computer-type screen display which represents the cumulative return on investment, as well as the cumulative return on investment based on such buy and hold strategy.

41. A method as in claim 37, further comprising providing computer-type screen display having an interactive computer interface which allows a user to select, for use in calculating trading results, any one of
(i) a manually specified set of simple moving averages,
(ii) a locked-in, previously-selected preferred set of simple moving averages, or
(iii) a periodically-updated set of simple moving averages.

42. A method as in claim 37, further comprising providing a computer-type screen display which shows each such hypothetical transaction as signaled by the back-testing process, including
(i) transaction date,
(ii) transaction action taken, and
(iii) accumulated value of an investment as of the transaction date,
using the then-current preferred set of simple moving averages.

43. A method as in claim 37 wherein “n” is at least 5.

44. A method as in claim 43, further comprising periodically updating the historical price information, from such resource database, to reflect current market information, and using the updated information to subsequently perform back testing, and corresponding selection of the then-current preferred set of simple moving averages, each time using a newly-randomly-selected set of simple moving averages, and by using results of such subsequently-performed back testing, generating additional transaction signals, and wherein, upon generation of a real time such transaction signal, a computer communicating such transaction signal to a market platform where the respective investment vehicle can be purchased and/or sold, and placing a transaction order based on such real time transaction signal.

45. A method as in claim 37, further comprising updating and compiling the historical price data to memory at predetermined spaced time intervals.

46. A method of making investment transaction decisions, comprising:
(a) selecting an investment vehicle;
(b) downloading, from a resource database, historical price information for the selected investment vehicle, for a selected period of time;
(c) employing a first group of randomly selected sets of “n” simple moving averages represented by “SMA1, SMA2, SMA3 . . . , where “n” is at least 3, back testing the set of simple moving averages using simple moving average crosses according to a first formula which allows shorting and ½ positions to obtain a first then-current preferred set of simple moving averages, and corresponding set of transaction signals, and corresponding first trading results;
(d) back testing a second group of randomly-selected sets of simple moving averages using simple moving average crosses according to the same first formula except disallowing one or both of shorting or ½ positions, to obtain a second then-current preferred set of simple moving averages, and a corresponding set of transaction signals, and corresponding second trading results;
(e) comparing the second trading results to the first trading results and thereby determining which of the first or second trading results would have produced a greater return on investment and selecting that respective back testing condition as preferred for generating future transaction signals;
(f) periodically updating the historical price data, from the resource database, and using the updated price data in subsequent back testing calculations; and
(g) generating transaction signals, according to the results selected, using the most current up-dated historical price data.

47. A method as in claim 46, further comprising providing a computer-type screen display having an interactive computer interface which allows a user to select, for use in computing trading results, any one of
(i) a manually specified set of simple moving averages,
(ii) a locked-in, previously-selected preferred set of simple moving averages, or
(iii) a periodically-updated set of simple moving averages.

48. A method as in claim 46, further comprising providing a computer-type screen display providing an interactive computer interface which allows a user to enable or disable half positions, and/or to enable or disable shorting, as screening criteria in calculating the back-test results.

49. A method as in claim 46, further comprising using a computer to calculate, as part of the back testing, the total return on investment using the selected set of simple moving averages, within the selected period of time.

50. A method as in claim 46, further comprising providing a computer-type screen display which shows each transaction as signaled by the back-testing process, including
(i) transaction date,
(ii) transaction action taken, and
(iii) accumulated value of an investment as of the transaction date,
using the then-current preferred set of simple moving averages.

51. A method as in claim 46, further comprising providing a computer-type screen display which shows average trade efficiency using the selected set of simple moving averages.

52. A method as in claim 46 wherein “n” is at least 5.

53. A method as in claim 52 wherein the back testing is performed by a computer and, when the computer generates a real time such transaction signal, the computer communicates with a market platform where the respective investment vehicle can be purchased and/or sold, and places a transaction order based on such real time transaction signal.

54. A data processing system, comprising:
(a) a cloud computer, configured
(i) to access a resource database containing historical market price information for multiple investment vehicles,
(ii) to download the historical price information for any selected investment vehicle in the resource database,
(iii) using predetermined criteria, in combination with downloaded such historical price information, to determine whether a market price for a selected investment vehicle is rising or falling, and
A. when the market price for the selected investment vehicle is rising, generating a transaction signal based on first simple moving average crosses according to a first set of signal generation criteria, and
B. when the market price for the selected investment vehicle is falling, generating a transaction signal based on second simple moving average crosses according to a second set of signal generation criteria, different from the first signal generation criteria; and
(b) at least one user computer, coupled to said cloud computer, said at least one user computer being configured
(i) to enable a user to select a specific investment vehicle whose price information is available from the resource database,
(ii) to communicate a selection of a respective investment vehicle to the cloud computer, and
(iii) to receive respective transaction signals from said cloud computer for the selected investment vehicle,
wherein the coupling of said at least one user computer to said cloud computer is optionally an internet-based connection.

55. A data processing system as in claim 54 wherein multiple user computers are coupled to said cloud computer.

56. A data processing system, comprising a computer system, said computer system being configured
(a) to access a resource database containing historical market price information for multiple investment vehicles;
(b) to enable a user to select a specific investment vehicle from the resource database;
(c) to download the historical price information for any selected invest ent vehicle in the resource database;
(d) to, using the historical price information so downloaded for such selected investment vehicle,
(i) using multiple sets of simple moving averages in sequence, each set containing at least “n” simple moving averages, represented by SMA1, SMA2, SMA3 . . . , where “n” is at least 3, back testing simple moving average crosses using a set of criteria to trigger transaction signals regarding theoretical historical transactions, thereby generating a separate set of theoretical historical transaction data and dates, and separate corresponding theoretical managed trading results, for each of the sets of simple moving averages so back tested,
(ii) selecting, as a then-current preferred set of simple moving averages, that back tested set of simple moving averages whose trading results, based on such transaction signals, provided greatest return on investment;
(e) periodically updating the information set, from the resource database, for the respective investment vehicle;
(f) after updating the data set, again back testing the investment vehicle using the updated data set, and
(g) generating any new transaction signals based on the updated data set and the same set of criteria.
